(19) United States
(12) Patent Application Publication
(10) Pub. No.: US 2026/0289268 A1
(43) Pub. Date: Sep. 24, 2026

(54) SYSTEM

(71) Applicant: SoftBank Group Corp., Tokyo (JP)

(72) Inventor: Natsumi KOBAYASHI, Tokyo (JP)

(73) Assignee: SoftBank Group Corp., Tokyo (JP)

(21) Appl. No.: 19/565,640

(22) Filed: Mar. 13, 2026

(30) Foreign Application Priority Data
Mar. 19, 2025 (JP) 2025-045055

(51) Int. Cl. G06N 3/0475; G06F 40/242; G06F 40/247; G06F 40/253; G06F 40/284; G06F 40/295; G06F 40/40; G06V 10/77; G06V 10/82; G06V 20/70; G10L 13/027

(52) U.S. Cl. CPC G06N 3/0475; G06F 40/242; G06F 40/247; G06F 40/253; G06F 40/284; G06F 40/295; G06F 40/40; G06V 10/7715; G06V 10/82; G06V 20/70; G10L 13/027

(57) ABSTRACT

A system includes a processor that is configured to analyze prompt data input by a user for instructing a generative AI model to execute a specific processing operation, and search for visual information related to the prompt data by using the generative AI model, analyze the visual information by using the generative AI model and generate a descriptive sentence that explains content of the visual information, and generate, by using the generative AI model and based on the generated descriptive sentence, a summary sentence including information that an advertiser desires to add.

### CROSS-REFERENCE TO RELATED APPLICATION

This application is based on and claims priority under 35 USC 119 from Japanese Patent Application No. 2025-045055 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating advertisement-related text from visual information suffer from several problems. First, existing systems typically rely on manually created image descriptions, which require significant human effort and are not scalable when a large number of images or advertisement creatives must be prepared. Second, even when automatic caption generation is used, such captions are usually limited to neutral descriptions of visual content and do not flexibly incorporate advertiser-specific information, such as product features, promotional messages, or campaign slogans, into a coherent and concise summary suitable for use in advertising contexts. Third, conventional systems generally do not leverage generative AI models in an integrated manner to both retrieve relevant visual information based on user-provided prompts and to generate tailored textual descriptions and summaries from such visual information. As a result, it is difficult to efficiently produce high-quality, context-aware advertisement summaries that are aligned with both the visual content and the advertiser's intended message. Moreover, prior systems often lack mechanisms to further adjust generated summaries based on a user's emotional state, thereby failing to optimize personalization and engagement. In addition, generated summaries and associated visual information are not always systematically stored and transmitted to advertisement display systems in a structured way, which hampers reuse, management, and deployment of the generated content across various advertising platforms. Accordingly, there is a need for a system that can, by using a processor and generative AI models, automatically analyze user prompts, retrieve and interpret relevant visual information, generate descriptive sentences and advertiser-oriented summaries, optionally adapt such summaries to user emotion, and store and provide these outputs to advertisement display systems in an efficient and integrated manner.

### SUMMARY

In order to solve the above-described problems, according to an aspect of the present invention, there is provided a system comprising a processor, wherein the processor is configured to analyze prompt data input by a user for instructing a generative AI model to execute a specific processing operation, and to search for visual information related to the prompt data by using the generative AI model. The processor is further configured to analyze the visual information by using the generative AI model and to generate a descriptive sentence that explains content of the visual information. In addition, the processor is configured to generate, by using the generative AI model and based on the generated descriptive sentence, a summary sentence including information that an advertiser desires to add, such as product attributes, promotional offers, or other marketing messages, thereby producing an advertisement-oriented summary that is consistent with the underlying visual content. In one embodiment, the processor is configured to analyze an emotional state of the user and to adjust the summary sentence in accordance with the emotional state, for example by modifying tone, emphasis, or wording to better match detected user sentiment. In another embodiment, the processor is configured to store the generated summary sentence and the visual information in a database and to transmit the generated summary sentence and the visual information to an advertisement display system, so that the generated content can be efficiently managed, reused, and deployed as part of advertisement creatives, including but not limited to alt text for images. By these means, the system enables an integrated workflow in which user prompts are interpreted, relevant visual information is retrieved and described, advertiser-specific information is incorporated into refined summaries, and the results are adapted, stored, and distributed for use in various advertising and accessibility contexts.

The term “system” refers to a combination of hardware and software components, including at least one processor and associated memory and interfaces, that cooperatively perform the functions described in the claims.

The term “processor” refers to any hardware component or combination of hardware components, such as a central processing unit (CPU), graphics processing unit (GPU), application-specific integrated circuit (ASIC), field-programmable gate array (FPGA), or a plurality thereof, capable of executing instructions to perform the operations recited in the claims.

The term “prompt data” refers to information, including text, symbols, or other user-input data, that is provided by a user to instruct a generative AI model to execute a specific processing operation or task.

The term “user” refers to an individual or entity that operates a client device or interface to input prompt data or otherwise interact with the system, including but not limited to end users, administrators, and advertisers when acting in such a role.

The term “generative AI model” refers to a machine learning model, such as a large language model, image generation model, or multimodal model, that is trained to generate output data, including text or images, based on input data such as prompt data or visual information.

The term “visual information” refers to data representing visual content, including but not limited to digital images, video frames, or graphical representations, that can be processed or analyzed by the generative AI model.

The term “analyze” refers to processing input data, such as prompt data, visual information, or user-related data, by applying algorithms or models, including generative AI models, to extract features, interpret meaning, classify content, or otherwise derive information used for subsequent processing steps.

The term “descriptive sentence” refers to a text output, typically one or more sentences in natural language, that explains or describes the content of the visual information in a manner understandable to a human reader.

The term “summary sentence” refers to a text output, typically one or more concise sentences in natural language, that is generated based on a descriptive sentence and includes additional information desired by an advertiser, forming a condensed expression suitable for use in an advertisement or related context.

The term “advertiser” refers to an individual, company, organization, or other entity that provides information to the system for the purpose of promoting products, services, brands, or campaigns, and that desires such information to be incorporated into generated summaries.

The term “information that an advertiser desires to add” refers to textual content provided or specified by an advertiser, including but not limited to product features, sales points, promotional offers, campaign slogans, and calls to action, that is intended to be incorporated into a summary sentence.

The term “emotional state of the user” refers to an inferred or detected condition of the user's emotions or affect, such as happiness, sadness, curiosity, or frustration, derived from user input, behavior, physiological signals, or other data indicative of user sentiment.

The term “adjust the summary sentence” refers to modifying one or more aspects of the generated summary sentence, including wording, tone, emphasis, length, or structure, based on additional information such as the user's emotional state.

The term “database” refers to any organized collection of data stored in one or more storage devices, including relational databases, NoSQL databases, or other data stores, that allows the generated summary sentences and visual information to be stored, retrieved, and managed.

The term “advertisement display system” refers to any system, platform, or service configured to present or distribute advertisements to users, including but not limited to web-based ad servers, search engine advertising platforms, social media advertising systems, and display networks.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

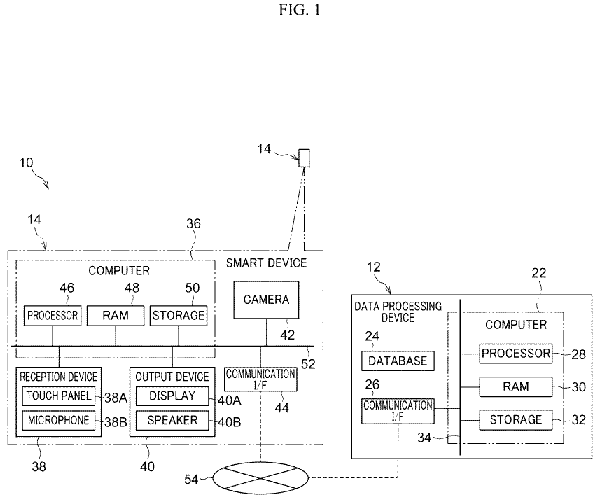

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

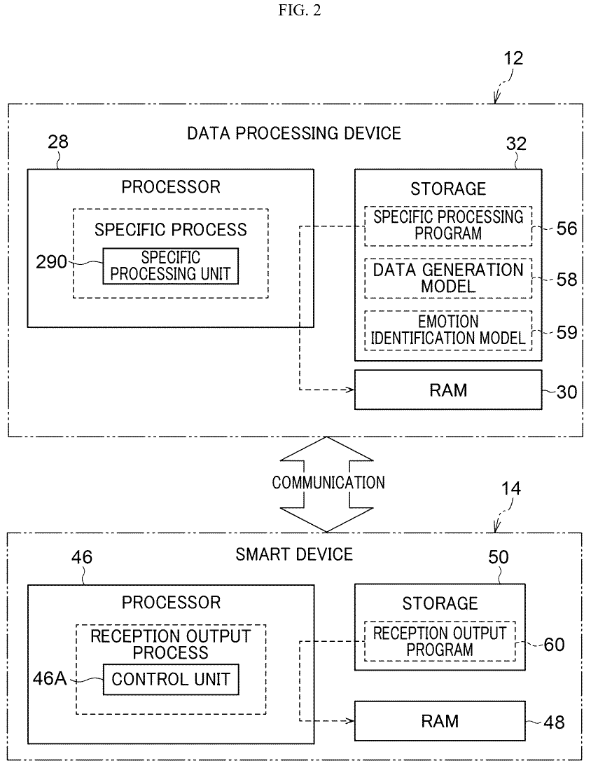

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information retrieval systems that handle visual information, such as images and videos, typically treat text queries and visual content as separate data domains. A server generally receives a user query, performs a keyword-based search in an index or via an external search service, and returns raw visual results such as image thumbnails and links. While such systems may be effective at retrieving visually related items, they do not reliably generate accurate, context-sensitive textual explanations of the retrieved visual information, nor do they integrate advertising information in a manner that is semantically aligned with both the user's intent and the actual visual content.

Moreover, existing systems that incorporate advertising information usually rely on static keyword matching or simplistic rules. As a result, the same advertisement may be attached to many different images solely because they share a superficial keyword, without considering what is actually depicted in the visual information. This can lead to irrelevant or confusing ad placements, wasted advertising resources, and a poor user experience. In addition, most systems do not provide a programmable, machine-readable way to structure the intermediate analysis of visual content and feed it into a generative AI model in a controlled manner. Instead, generative AI, if used at all, is often invoked in an ad hoc fashion with unstructured prompts, which can result in inconsistent quality and unpredictable generations.

From the standpoint of computer technology, these limitations manifest as inefficient use of computing resources, fragmented processing pipelines, and lack of systematic orchestration between multiple specialized components, such as natural language processing modules, image analysis modules, generative AI models, and advertisement management modules. The server may repeatedly perform redundant operations, such as re-parsing queries or re-analyzing images without caching or structuring intermediate results. The lack of a unified processing framework also makes it difficult to guarantee latency, scalability, and robustness when processing large volumes of visual information and generating corresponding text and advertisement content in real time.

There is therefore a need for a computer-implemented technique that improves the way a server processes user input, visual information, and advertisement information as an integrated pipeline. In particular, there is a need for a server that (i) systematically converts a user's prompt sentence into normalized search terms, (ii) uses those search terms to retrieve candidate visual information from external information sources, (iii) performs structured image analysis to obtain object and scene information, (iv) constructs well-defined prompt sentences for a generative AI model based on that structured analysis, and (v) generates explanation sentences and ad-integrated summary sentences in a repeatable and controllable manner. Such a technique should reduce unnecessary processing, provide a clear division of roles among functional units, and improve the overall technical performance and reliability of the visual information retrieval and advertising system as a whole.

The specific processing by the specific processing unit 290 of the data processing device 12 in Example 1 is realized by the following means.

The present invention provides a server comprising a processor configured to receive, from a terminal operated by a user, prompt data that is input by the user for instructing a generative AI model to execute a specific processing operation, analyze the prompt data by a natural language processing unit to extract search terms, search for visual information through an external information source on a basis of the extracted search terms, select visual information from a plurality of pieces of acquired visual information in accordance with a predetermined criterion, input the selected visual information to an image analysis unit and acquire an analysis result including object information and scene information, integrate the analysis result as structured data and generate a prompt sentence for input to the generative AI model on a basis of the integrated structured data, cause the generative AI model to execute a natural language generation process by using the generated prompt sentence so as to generate an explanation sentence describing content of the visual information, cause the generative AI model to execute a natural language generation process so as to generate a summary sentence in which advertisement information stored in an advertisement information storage unit is incorporated in a natural manner on a basis of the explanation sentence and the advertisement information, and configure the summary sentence and the visual information as search result display data and transmit the search result display data to the terminal. This enables a computer-implemented pipeline in which query analysis, visual information retrieval, structured image understanding, generative text creation, and advertisement integration are orchestrated as coordinated operations within the server, thereby improving the technical efficiency, scalability, and relevance of visual information presentation and advertisement delivery compared to conventional systems.

The term “processor” refers to one or more hardware-based computing elements, such as a central processing unit, a graphics processing unit, or another arithmetic and logic execution unit, configured to execute instructions stored in a memory to perform the functions described in the present specification.

The term “terminal” refers to an information processing apparatus operated by a user, including at least one of a portable communication apparatus, a tablet-type apparatus, a desktop-type apparatus, or another user interface apparatus capable of transmitting data to and receiving data from a server over a communication network.

The term “user” refers to a human operator who interacts with the terminal to input a prompt sentence or other operation instruction and to view or otherwise consume visual information and text information supplied by the server.

The term “prompt data” refers to digital text information, including a prompt sentence, that is input by the user into the terminal and transmitted to the server as an instruction or request for a generative AI model or other processing component to execute a specific processing operation.

The term “prompt sentence” refers to a natural language expression included in the prompt data and comprising one or more words, phrases, or sentences that indicate a user's intention, topic, or request to be processed by the generative AI model.

The term “generative AI model” refers to a machine learning model, such as a neural network based language model or multimodal model, that is trained on data and configured to generate output data, including natural language text, in response to an input prompt.

The term “natural language processing unit” refers to a functional component, implemented by execution of software on the processor, that performs natural language analysis on text data, including operations such as tokenization, part-of-speech tagging, entity recognition, or keyword extraction.

The term “search terms” refers to text tokens, words, or phrases extracted from prompt data that are used as retrieval keys or query strings for searching visual information in an external information source or other data store.

The term “external information source” refers to a data providing system, such as a remote server, a database service, or an application programming interface, that supplies visual information or related metadata to the server in response to a search request.

The term “visual information” refers to digital data representing visual content, including at least image data or moving image data, that can be displayed to a user or analyzed by an image analysis unit.

The term “predetermined criterion” refers to one or more conditions, rules, or parameters, such as relevance, resolution, quality, or duplication status, that are used by the processor to select visual information from among multiple acquired items.

The term “image analysis unit” refers to a functional component, implemented by software executed on the processor or by an external service, that receives visual information and outputs analysis results including one or more of object information, scene information, or other recognition results derived from the visual content.

The term “object information” refers to data indicating identified items or regions within visual information, including at least object categories, labels, or positions, and optionally including confidence scores or bounding region information.

The term “scene information” refers to data indicating an overall context or situation represented in visual information, including at least location context, environment type, event type, or temporal context associated with the visual content.

The term “analysis result” refers to structured or semi-structured data output from the image analysis unit, including at least object information and scene information, and optionally including text detection results or other recognition attributes.

The term “structured data” refers to data that is organized according to a predefined schema, format, or data model, such as key-value pairs, tables, or hierarchical documents, enabling systematic processing and use as input to the generative AI model.

The term “prompt sentence for the generative AI model” refers to a text sequence generated by the processor based on structured data, the text sequence including instructions and content elements formatted for input to the generative AI model to induce a desired natural language generation behavior.

The term “natural language generation process” refers to processing performed by the generative AI model in which the model receives an input prompt and outputs natural language text according to learned parameters and probabilistic inference.

The term “explanation sentence” refers to natural language text generated by the generative AI model that describes or explains content of visual information in a manner understandable by a user.

The term “summary sentence” refers to natural language text generated by the generative AI model that concisely represents key information related to visual information and incorporates advertisement information in a manner suitable for display as part of search results or advertisements.

The term “advertisement information storage unit” refers to a storage component, such as a memory or database, that stores advertisement information including at least advertising text, campaign parameters, or related metadata.

The term “advertisement information” refers to data provided for promotion of a product, service, or entity, including at least advertising text, slogans, or campaign messages, which is used for generating a summary sentence.

The term “natural manner” refers to a mode of integration in which advertisement information is incorporated into a sentence such that the overall sentence maintains grammatical correctness, semantic coherence, and contextual relevance to the associated visual information.

The term “search result display data” refers to data formatted for output to the terminal, including at least visual information and associated text information such as explanation sentences and summary sentences, and optionally including layout information or identifiers.

The term “user operation history information” refers to data representing past interactions by the user with the terminal or the server, including at least search inputs, selection operations, click actions, or browsing behaviors.

The term “user state information” refers to data indicating one or more conditions related to the user, such as usage context, interaction pattern, or biometric-related signals, that are obtainable from the terminal or other sensors and usable to estimate an emotional state.

The term “emotional state” refers to a classification or estimation of the user's affective condition, such as a state of interest, satisfaction, frustration, or curiosity, inferred from user operation history information or user state information.

The term “style of the generated summary sentence” refers to one or more linguistic characteristics of the summary sentence, including at least tone, formality level, or degree of detail, that can be adjusted by controlling the prompt or output of the generative AI model.

The term “length of the generated summary sentence” refers to a quantitative measure, such as a number of words, phrases, or characters, indicating the size of the summary sentence.

The term “emphasis content of the generated summary sentence” refers to particular informational elements, such as certain features of the visual information or aspects of the advertisement information, that are highlighted or stressed in the generated summary sentence.

The term “information storage unit” refers to a memory device or database system that stores digital information, including explanation sentences, summary sentences, visual information, and corresponding identification information, in an associated manner.

The term “identification information” refers to data, such as an identifier, index, or key, that uniquely or distinctively associates explanation sentences, summary sentences, and visual information with each other within the information storage unit.

The term “distribution data” refers to formatted data constructed from stored explanation sentences, stored summary sentences, and corresponding visual information, which is prepared in a form suitable for transmission to an advertisement distribution processing apparatus or another external system.

The term “advertisement distribution processing apparatus” refers to an external processing system that receives distribution data and performs operations related to advertisement delivery, such as selecting, scheduling, or serving advertisement content to user-facing devices.

The server is implemented as an information processing apparatus comprising at least one processor, a memory, a storage device, and a network interface. The server executes a program that implements a natural language processing module, an image retrieval module, an image analysis module, a generative AI model interface module, an advertisement management module, and a result formatting module. The server is connected via a communication network to one or more terminals and to one or more external information sources that provide visual information and metadata.

The terminal is implemented as a general-purpose computing device, such as a portable communication device, a tablet-type device, or a desktop-type device, running an operating system and a web browser or a native application. The terminal provides a graphical user interface that allows the user to input a prompt sentence, to send the prompt sentence to the server, and to display visual information together with generated text. The terminal may run accessibility software such as a screen reader, and the terminal presents explanation sentences and summary sentences as alternative text or accessible labels so that visually impaired users can understand the content of images.

The user operates the terminal to input a prompt sentence that specifies desired visual content. The user enters the prompt sentence into a text input field provided by an information search tool executed on the terminal. For example, the user may input a prompt sentence such as “A photo of Mt. Fuji in winter,” “Night view of a city skyline with fireworks,” or “A person running in a park at sunrise.” The terminal encodes the prompt sentence as character data, for example as a UTF-8 encoded string, and transmits the prompt sentence to the server using a network communication protocol such as HTTPS.

The server stores the received prompt sentence in a memory region and invokes the natural language processing module to analyze the prompt sentence. The natural language processing module is implemented by software libraries such as a statistical or neural network based tokenizer, part-of-speech tagger, and named entity recognizer. The server converts the prompt sentence into a sequence of tokens, assigns part-of-speech tags, and identifies named entities corresponding to locations, objects, or events. The server then applies keyword extraction logic that selects certain tokens and entities as search terms, and normalizes them using techniques such as lowercasing, lemmatization, and stop word removal. This processing creates a compact and semantically meaningful set of search terms that will be used as keys for visual information retrieval.

The server uses the image retrieval module to send search requests to external information sources, such as an image database or an image search application programming interface. The server constructs a query string based on the search terms and includes filter parameters such as image size, aspect ratio, or content safety flags. The server sends a request via the network interface and receives a list of candidate images with associated metadata. The metadata may include image identifiers, file formats, resolutions, thumbnail addresses, and textual descriptors.

The server applies selection criteria to the candidate images in order to choose an appropriate subset of visual information for further analysis. The server evaluates each candidate based on parameters such as resolution, file size, format type (for example, JPEG or PNG), and relevance scores supplied by the external information source. The server discards images that do not satisfy a predetermined resolution threshold or that are duplicates of other images in the candidate list. The server then ranks the remaining images according to a relevance metric that combines external scores and internal heuristics, and the server selects a limited number of images, such as the top N items, for subsequent processing. This selection reduces the amount of data that must be processed by the image analysis module and thereby improves the computational efficiency and reduces network and storage load.

The server invokes the image analysis module to analyze each selected image. The image analysis module is implemented as a neural network-based image recognition system, for example a convolutional neural network or a vision transformer. The server decodes each image into pixel arrays and normalizes pixel values to a predefined numerical range. The server inputs the normalized images into the neural network, which comprises multiple layers such as convolutional layers, pooling layers, normalization layers, and fully connected layers. The neural network has been trained using supervised learning on a large set of labeled images, with a loss function such as cross-entropy between predicted labels and ground truth labels, and with weight updates performed by an optimization algorithm such as stochastic gradient descent or an adaptive gradient method.

The server obtains from the image analysis module output vectors that represent probabilities or confidence scores for a set of object categories and scene categories. The server converts the output vectors into human-readable object information and scene information by selecting labels whose scores exceed a threshold. The server may also obtain bounding region coordinates for detected objects, as well as embeddings that characterize the global scene. The server constructs a structured representation of the analysis result as a data structure such as a record or a hierarchical object that contains object labels, scene labels, confidence scores, and spatial relationships. This structured representation is stored in memory as structured data with explicit fields that can be used by downstream modules.

The server uses the generative AI model interface module to construct an input prompt for a generative AI model. The generative AI model is implemented as a large neural network-based language model trained on a large corpus of text using a language modeling objective. The model may have an architecture comprising an embedding layer, multiple attention-based layers, and a final projection layer that outputs probability distributions over tokens in a vocabulary. During training, the model parameters are updated using backpropagation and an optimization algorithm based on an error function such as cross-entropy between predicted token sequences and target sequences.

The server converts the structured data from the image analysis module into a textual description of detected objects and scenes, for example “Detected objects: mountain, lake, snow, clear sky. Scene: winter landscape.” The server incorporates this description into a prompt sentence for the generative AI model together with instructions that specify the desired style, length, and language of the output. For example, the server constructs a prompt sentence such as “You are an assistant that writes clear image descriptions. Detected objects: mountain, lake, snow, clear sky. Detected scene: winter landscape in a cold region. Write a detailed one-paragraph description in English that an ordinary user can understand.” The server sends this prompt sentence as a sequence of tokens to the generative AI model and receives an explanation sentence as output.

The server post-processes the explanation sentence to ensure that the length and content satisfy system constraints. The server enforces a maximum character count, removes undesired patterns by applying text filters, and normalizes punctuation and whitespace. The server may also apply a translation module if the explanation sentence must be converted into a different language. By using structured data as the basis of the prompt sentence, the server ensures that the generative AI model receives consistent and well-formed inputs, which reduces variability and improves reliability in the output compared to unstructured prompts directly derived from user queries.

The server uses the advertisement management module to retrieve advertisement information and to integrate the advertisement information with the explanation sentence. The server stores advertisement information in an advertisement information storage unit such as a database, where entries include advertisement texts, campaign identifiers, targeting parameters, and constraints such as maximum length and prohibited terms. The server selects advertisement information that is relevant to the current visual information by matching search terms, object labels, scene labels, or embeddings derived from the image analysis module against the targeting parameters in the advertisement database. The server then constructs a second prompt sentence for the generative AI model that includes the explanation sentence and the selected advertisement information, together with an instruction to generate a concise summary sentence that naturally incorporates the advertisement content. For example, the server may construct a prompt sentence such as “Image description: ‘This image shows a snow-covered mountain with a calm lake in the foreground under a clear winter sky.’ Advertiser message: ‘Plan your winter trip with our travel package.’ Write a single sentence, no more than 30 words, that describes the image and naturally includes the advertiser message.”

The server transmits the second prompt sentence to the generative AI model, obtains a summary sentence as output, and applies post-processing to enforce length and content requirements. The server may enforce a maximum token count by truncating or regenerating the summary sentence, and the server may apply pattern matching to remove offensive or irrelevant text. The server then associates the summary sentence, the explanation sentence, and the corresponding visual information with identification information and stores them in an information storage unit for later retrieval and analysis.

The terminal receives from the server search result display data that includes visual information, explanation sentences, and summary sentences. The terminal renders a user interface that displays the images, the explanation sentences, and the summary sentences in association with each other. The terminal may, for example, display the explanation sentence as a caption below each image and the summary sentence in a designated advertisement area adjacent to the image. The terminal also assigns the explanation sentence and the summary sentence to attributes usable by accessibility tools so that a screen reader can read the content aloud. This arrangement improves accessibility and allows users with visual impairments to obtain meaningful information about the images without manual human annotation.

The server, by structuring intermediate data and by controlling the way prompts to the generative AI model are constructed, improves the efficiency and reliability of the overall system. The server avoids repeatedly performing full natural language analysis on similar queries by caching structured data and explanation sentences, thereby reducing processing time for subsequent requests. The server reduces unnecessary network traffic by filtering and selecting visual information before invoking computationally intensive image analysis and generative processing. The server also uses structured analysis results as features for ranking and filtering visual information, which improves the relevance of selected images and reduces error rates compared to simpler keyword-based methods.

The server improves technical performance in several ways. First, the server reduces latency and computational load by using explicit selection criteria and structured data to limit the size of the image set that must be analyzed and described. Second, the server increases the accuracy of text descriptions by using object information and scene information as features in the prompt sentence, enabling the generative AI model to focus on salient aspects of the visual content. Third, the server improves data management by storing structured analysis results, explanation sentences, and summary sentences with identification information, enabling efficient retrieval, analytics, and reuse for future requests or model retraining. Fourth, the server reduces communication overhead between components by encoding only necessary structured features rather than raw pixel data when preparing prompt sentences.

The server implements specific neural network architectures and training methods to further improve performance. The image analysis module may use a convolutional neural network with a fixed number of layers, kernel sizes, and activation functions, trained with data augmentation techniques such as random cropping, flipping, and color jittering to increase robustness. The generative AI model may use an attention-based architecture with multi-head attention layers, positional encodings, and layer normalization, and it may be fine-tuned on domain-specific corpora containing image descriptions and advertisement texts. During fine-tuning, the server may compute loss functions that combine language modeling loss with additional terms that penalize irrelevant or repetitive content. Weight updates may be performed using an optimizer with adaptive learning rates, and model parameters may be regularly updated based on performance metrics measured on validation data.

The server applies rules and strategies that differ from manual human workflows. Instead of manually reading each image and composing an explanation, the server uses numerical feature vectors, probability distributions, and ranking algorithms to automatically prioritize information. The server determines which object labels and scene labels to include in the structured data by applying non-obvious thresholds and weighting schemes that are tuned to minimize error rates in explanation quality. The server dynamically adjusts the style and length of the generated summary sentence based on estimated user emotional state and device constraints, which is difficult to replicate manually across large-scale real-time systems.

The server can be implemented using various hardware and software configurations. For example, the server may run on a virtualized machine or container environment, using a general-purpose operating system, a web framework to accept HTTP requests from terminals, a relational or non-relational database to store structured data, and runtime environments for natural language processing and neural network inference. The terminal may be implemented in different form factors and operating platforms, provided that it can send prompt sentences and display results as described. The image analysis module and generative AI model may be hosted on the same physical server or on separate computing nodes with specialized accelerators such as graphics processing units or tensor processing units.

The server may also support alternative embodiments. The structured data may include additional features such as color histograms or texture descriptors to refine object and scene interpretation. The generative AI model may be replaced or supplemented with other generative architectures, such as encoder-decoder models or diffusion-based text generators, provided that the models accept prompt sentences and output natural language text. The advertisement information storage unit may use different indexing structures to accelerate matching between visual content features and advertisement parameters. The natural language processing module may be extended to handle multiple languages and to dynamically switch output language based on user settings on the terminal.

The user thus benefits from a system in which the server orchestrates a series of specialized modules to provide detailed explanations and ad-integrated summaries for visual information. The system does not merely automate a human mental process; instead, the server transforms text and image data into structured representations, controls complex neural network models, and optimizes data flow and resource usage across computing hardware. This technical configuration produces measurable improvements in processing speed, accuracy of image descriptions, robustness of advertisement integration, and scalability for large-scale deployment.

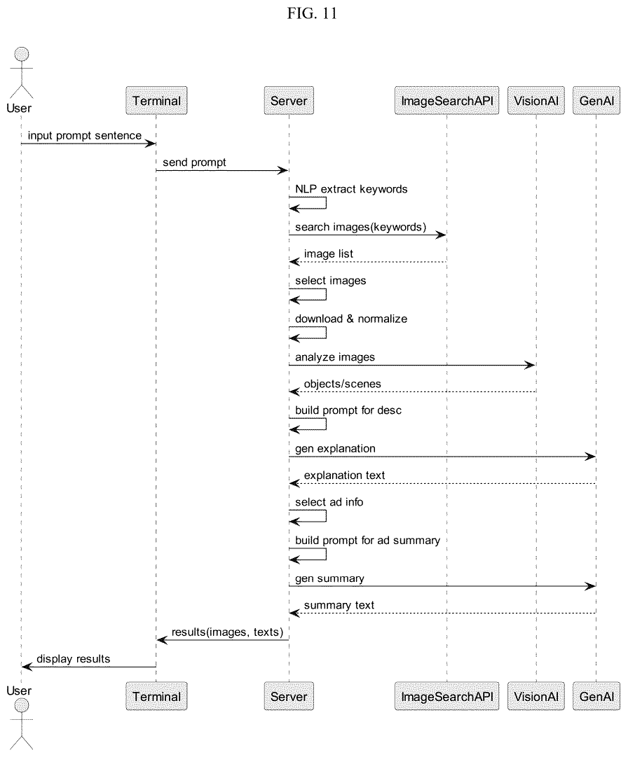

The following describes the processing flow using FIG. 11.
Step 1:

The user operates the terminal to input a prompt sentence into an input field of an information search tool. The terminal receives, as input, user keystrokes and converts them into a text string such as “A photo of Mt. Fuji in winter.” The terminal encodes this string as character data (for example, UTF-8 encoded text) and stores it temporarily in a local buffer. The terminal then outputs an HTTP request that includes the prompt sentence in a request body, and sends this request to the server over a network using a secure protocol.
Step 2:

The server receives, as input, the HTTP request containing the prompt sentence from the terminal. The server decodes the request body to obtain the raw text of the prompt sentence and stores it in a memory area. The server validates the input by checking conditions such as non-emptiness, maximum allowed length, and permitted character types. Based on this validation, the server outputs either an error response (if validation fails) or a normalized prompt sentence string (if validation succeeds) that will be passed to a natural language processing module.
Step 3:

The server uses the natural language processing module to analyze, as input, the normalized prompt sentence string. The server performs tokenization to split the sentence into tokens, applies part-of-speech tagging to each token, and executes named entity recognition to detect entities such as locations or objects. The server then computes keyword candidates by selecting nouns and named entities and removing stop words. As output, the server produces a list of search terms, for example [“Mt. Fuji”, “winter”, “photo”], and stores this list as an array or similar data structure in memory.
Step 4:

The server normalizes, as input, the list of search terms generated in Step 3. The server converts alphabetic characters to lower case, applies lemmatization or stemming to unify inflected forms, and removes generic or low-information terms such as “photo” or “picture.” The server may also map synonyms to a canonical form using a predefined dictionary. As output, the server generates a cleaned and normalized search-term list, such as [“mt fuji”, “winter”], and formats this list into a query string suitable for calling an external image search interface.
Step 5:

The server uses the image retrieval module to send, as input, the normalized search terms to an external information source. The server constructs an HTTP request that includes the query string (for example, “mt fuji winter”), filter parameters (such as image size and content safety level), and authentication information. The external information source executes its own search and returns, as output to the server, a response containing structured data, for example a JSON document listing candidate images with fields such as URLs, titles, resolutions, and thumbnail links. The server parses this document and produces an internal list of candidate visual information items.
Step 6:

The server evaluates, as input, the list of candidate visual information items obtained in Step 5. The server reads attributes such as image resolution, file format, estimated relevance score, and source domain. The server performs data operations including filtering (removing items with resolution below a threshold), deduplication (eliminating identical URLs), and ranking (sorting items in descending order of relevance score or a weighted combination of score and resolution). As output, the server selects a subset of visual information items, such as the top N images, and produces a reduced list of image metadata that will be passed to the image analysis module.
Step 7:

The server downloads, as input, the metadata for each selected visual information item from Step 6. For each item, the server issues an HTTP GET request to the image URL, receives binary image data (for example, JPEG or PNG byte streams), and decodes the binary data into pixel arrays. The server then standardizes the images by resizing them to a predefined width and height, normalizing pixel values to a numerical range, and optionally converting color formats (for example, from BGR to RGB). As output, the server generates a batch of normalized image tensors or arrays that are prepared as inputs to the image analysis module.
Step 8:

The server inputs, as input, the batch of normalized image arrays into the image analysis module implemented by a neural network. The server performs a forward pass of the arrays through a pre-trained vision model, such as a convolutional network or a transformer-based vision network, which computes feature maps via convolution, pooling, and attention operations. The model outputs probability distributions over predefined object classes, scene classes, and possibly bounding boxes. As output, the server obtains, for each image, a set of object labels with confidence scores, scene labels with confidence scores, and optional spatial coordinates, and stores these results as structured analysis data.
Step 9:

The server aggregates, as input, the structured analysis data for each image generated in Step 8. The server selects object labels and scene labels whose confidence scores exceed a predetermined threshold, groups related labels into categories (for example, “location,” “natural feature,” “activity”), and constructs a unified representation that may also include global feature vectors. The server encodes this representation as a structured data object, for example a record with fields “objects,” “scenes,” “confidences,” and “positions.” As output, the server produces one structured analysis object per image to be used when generating prompt sentences for the generative AI model.
Step 10:

The server constructs, as input, each structured analysis object coming from Step 9. For each image, the server converts object and scene labels into short textual fragments, such as “mountain,” “snow,” “lake,” and “winter landscape.” The server combines these fragments into a description template and appends instructions that define the desired language, style, and length of the output. For example, the server forms a prompt sentence such as “You are an assistant that writes clear image descriptions. Detected objects: mountain, snow, lake. Detected scene: winter landscape. Write a detailed one-paragraph description in English.” As output, the server produces one prompt sentence per image as a text string suitable for input into the generative AI model.
Step 11:

The server transmits, as input, each generated prompt sentence from Step 10 to the generative AI model. The server tokenizes the prompt sentence into tokens, feeds the tokens into a trained language model, and initiates a decoding process such as greedy decoding or beam search to predict successive tokens of an output sequence. The model applies internal operations, including attention over previous tokens and transformation via multiple neural layers, and computes probability distributions for each next token. As output, the server collects the generated tokens, converts them back into text, and obtains an explanation sentence that describes the content of the corresponding visual information. The server stores these explanation sentences in association with image identifiers.
Step 12:

The server retrieves, as input, the explanation sentences produced in Step 11 and the corresponding image identifiers. The server applies post-processing operations such as trimming leading and trailing whitespace, ensuring that sentences end with appropriate punctuation, and truncating or regenerating text that exceeds a maximum length limit. The server may apply validation checks to detect undesired patterns or prohibited terms, and if such patterns are found, the server may initiate re-generation with modified parameters. As output, the server produces a set of cleaned explanation sentences aligned with each visual information item.
Step 13:

The server queries, as input, the explanation sentences and structured analysis data to select suitable advertisement information. The server sends a query to an internal advertisement database using fields such as search terms, object labels, and scene labels as keys. The advertisement database returns candidate advertisement records that include advertisement texts, targeting metadata, and constraints. The server filters these records by checking conditions such as language compatibility, campaign status, and maximum allowed length. As output, the server yields a selected advertisement text and associated parameters for each image or group of images.
Step 14:

The server constructs, as input, an explanation sentence and the corresponding advertisement text from Step 13. The server composes a second prompt sentence for the generative AI model, including the explanation sentence as contextual information and the advertisement text as content to be incorporated. The server appends instructions specifying that the generative AI model should output a concise sentence that both describes the image and naturally embeds the advertisement. For example, the server may generate a prompt sentence such as “Image description: ‘This image shows a snow-covered mountain and a calm lake in winter.’ Advertiser message: ‘Book your winter trip with our special offer.’ Write one sentence, no more than 30 words, that describes the image and naturally includes the advertiser message.” As output, the server produces a set of ad-integration prompt sentences.
Step 15:

The server sends, as input, each ad-integration prompt sentence from Step 14 to the generative AI model. The server again tokenizes the text, feeds it into the language model, and executes a controlled decoding process, optionally constraining maximum output length and penalizing repetitions. The language model generates an output token sequence representing a summary sentence that integrates the advertisement content. As output, the server reconstructs the summary sentence from the tokens, stores it in association with the corresponding image identifier and explanation sentence, and records any metadata such as generation time or model parameters used.
Step 16:

The server refines, as input, the generated summary sentences obtained in Step 15. The server checks each summary sentence against constraints such as maximum character count, prohibited phrases, and style guidelines. The server may apply rule-based transformations, such as capitalizing the first letter, removing extraneous whitespace, or replacing certain terms with standardized alternatives. If a summary sentence fails validation, the server may alter the prompt or sampling parameters and request a new generation. As output, the server acquires a validated set of summary sentences that are ready for presentation to the user.
Step 17:

The server assembles, as input, the cleaned explanation sentences, validated summary sentences, and associated visual information items. The server constructs a data structure, such as a list of result objects, each object containing fields for image URL, explanation sentence, summary sentence, and optional layout hints or identifiers. The server serializes this structure into a response format, such as a JSON document, adding any required metadata (for example, timestamps or request identifiers). As output, the server produces search result display data suitable for transmission to the terminal.
Step 18:

The server transmits, as input, the search result display data created in Step 17 to the terminal that issued the original request. The server uses a network interface to send an HTTP response containing the serialized data. The terminal receives this response, parses the data, and extracts individual fields such as image URLs and text strings. As output, the terminal updates its user interface to render the images alongside the explanation sentences and summary sentences, and, if accessibility features are enabled, the terminal assigns the text as alternative descriptions for screen readers.
Step 19:

The server receives, as input, interaction signals from the terminal, such as further prompt sentences, image selection actions, or advertisement clicks. The server logs these actions together with associated identifiers in an internal analytics store. The server performs data aggregation and analysis on the logs, computing statistics such as click-through rates and generation error frequencies. As output, the server may adjust thresholds, selection criteria, or prompt construction parameters for future requests, thereby refining model usage, reducing latency, and enhancing the quality and relevance of generative AI outputs over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information presentation systems that use generative artificial intelligence models typically process user input in a direct and monolithic manner: a user supplies a short text query, a generative model returns a textual output, and, separately, search engines return visual information such as images or videos. In such systems, there is little or no structural coordination between (i) the way prompt sentences are constructed for the generative model, (ii) the way candidate visual information is retrieved and analyzed, and (iii) the way final descriptive texts and summary texts are generated and delivered to user devices. As a result, these systems often suffer from several technical drawbacks.

First, the absence of a structured prompt generation pipeline that takes into account image-level annotations and user context leads to suboptimal use of computational resources and model capacity. Generative models may be repeatedly queried with loosely defined prompts that do not incorporate machine-readable labels or annotations extracted from visual information, causing redundant processing, inconsistent descriptions, and increased latency. This degrades the efficiency of server-side processing and reduces throughput of the overall system.

Second, conventional systems do not tightly integrate image analysis devices with generative models in a feedback loop that refines prompt sentences based on label information or annotation information. Visual information retrieved from network resources is often presented with simple captions or metadata provided by content sources or search engines. Without systematically feeding structured annotation information back into a generative model, the system cannot generate consistent, context-aware descriptive texts that faithfully explain visual content while aligning with the user's original intent. This limits both the accuracy and the coherence of descriptions and thereby reduces the usefulness of the system for users, including users with visual impairments who rely heavily on descriptive text and audio output.

Third, conventional systems lack a dynamic relevance evaluation mechanism that jointly considers prompt data, descriptive texts, summary texts, and associated visual information in order to select and adaptively improve presentation of content. In many implementations, ranking logic is static or minimally informed by historical interaction data. Prompt templates used for generative models remain fixed, and parameters of evaluation processes are not systematically updated based on stored usage data. Consequently, the system cannot efficiently learn from past behavior to improve the quality and relevance of future outputs, resulting in inefficient utilization of storage, network bandwidth, and processing resources.

Fourth, many existing solutions do not provide a technically integrated method to transform AI-generated descriptive texts and summary texts into data structures that are optimized for accessibility functions on terminals, such as audio output functions for visually impaired users. Typically, accessibility is implemented at the device or operating system level without coordinated formatting of server-generated content. Without server-side structuring of output specifically designed for user support functions, assistive technologies on terminals may need additional local processing or may fail to capture semantic relationships between visual information and textual descriptions, which can lead to inconsistent or incomplete audio output.

Accordingly, there is a need for an improved computer-implemented technique that: (i) systematically constructs and manages prompt sentences for a generative information processing model in conjunction with image analysis and network retrieval; (ii) generates descriptive texts and summary texts that incorporate advertisement or additional information in a structured and context-aware manner; (iii) evaluates and selects visual information and associated texts based on relevance using stored evaluation results; and (iv) prepares the resulting content in a format optimized for accessibility-related user support functions on terminals. Such a technique should improve the efficiency, accuracy, and consistency of server-side processing, reduce redundant model calls, and enhance the technical performance of the overall information processing system, including for users with visual impairments.

The specific processing by the specific processing unit 290 of the data processing device 12 in Application Example 1 is realized by the following means.

The present invention provides a server comprising a processor configured to receive, via a terminal operated by a user, prompt data for instructing a generative information processing model to execute predetermined information processing, analyze the prompt data, generate, based on the analyzed prompt data, a prompt sentence constructed from a template sentence including the prompt data, cause the generative information processing model to process the prompt sentence, and acquire, via an information retrieval device, candidate visual information related to the prompt data from a network; obtain, for each item of the candidate visual information, label information or annotation information by using an image analysis device, and generate, by inputting a second prompt sentence including the label information or the annotation information and the prompt data into the generative information processing model, a descriptive text that explains content of the visual information; generate, based on the descriptive text and the prompt data, a summary text including advertisement information or additional information by using the generative information processing model; perform an evaluation process on the descriptive text, the summary text, and the visual information based on relevance, select visual information according to a result of the evaluation process, and transmit the selected visual information and corresponding descriptive text and summary text to the terminal; structure the descriptive text and the summary text as terminal display data so that the descriptive text and the summary text transmitted to the terminal are outputtable as audio information by a user support function including an audio output function for visually impaired users; and store the descriptive text, the summary text, the visual information, the prompt data, and an evaluation result obtained in the evaluation process in an associated manner in a searchable recording device, and update at least one of a template of the prompt sentence to be input to the generative information processing model and a parameter of the evaluation process based on the stored information. This enables a coordinated and technically improved processing pipeline in which prompt sentences are adaptively generated and refined using annotation information, relevance-based evaluation is continually optimized using stored interaction data, and output data structures are formatted for efficient consumption by terminal-side accessibility functions, thereby improving computational efficiency, response consistency, and accessibility performance of the overall information processing system.

The term “processor” refers to a hardware computation unit, or a combination of hardware computation units, configured to execute program instructions to perform information processing, including control of data input, data output, data storage, and communication with external devices.

The term “terminal” refers to an information processing apparatus operated by a user, including but not limited to a personal computer, a smartphone, a tablet, or a similar device, that is capable of transmitting data to and receiving data from a server via a communication network.

The term “user” refers to a human operator who interacts with the terminal by providing input data, including prompt data, and receiving output data, including visual information, descriptive texts, and summary texts.

The term “prompt data” refers to input information provided by the user to instruct a generative information processing model to perform predetermined processing, the input information including, for example, a keyword, a phrase, a sentence, or a set of parameters representing a requested topic or task.

The term “generative information processing model” refers to a machine-implemented model, such as a statistical model or neural network model, configured to generate output data including natural-language text or other content in response to input data including a prompt sentence.

The term “prompt sentence” refers to a text string generated based on prompt data, optionally combined with additional information such as template text, label information, or annotation information, and supplied as input to a generative information processing model to control behavior of the model.

The term “template sentence” refers to a predetermined text pattern including at least one insertion position into which prompt data or other variable information is inserted to generate a prompt sentence to be input to a generative information processing model.

The term “information retrieval device” refers to a functional unit, implemented by hardware and software, that executes retrieval processing on a communication network to acquire candidate visual information on the basis of a query related to prompt data or a prompt sentence.

The term “visual information” refers to data representing visual content, including but not limited to still image data, moving image data, and associated metadata, that can be presented to a user via a display device on a terminal.

The term “candidate visual information” refers to one or more items of visual information retrieved from a communication network or storage device in response to a query based on prompt data or a prompt sentence, prior to a selection process based on evaluation.

The term “image analysis device” refers to a functional unit, implemented by hardware and software, configured to analyze visual information and to output machine-readable information such as label information, annotation information, detected objects, or other features corresponding to the visual information.

The term “label information” refers to classification information output by an image analysis device, the classification information indicating categories, objects, scenes, or concepts recognized in corresponding visual information.

The term “annotation information” refers to descriptive metadata generated by an image analysis device, including labels, detected objects, regions of interest, or short textual notes, which are associated with corresponding visual information.

The term “descriptive text” refers to a natural-language text generated by a generative information processing model on the basis of prompt data, label information, annotation information, or combinations thereof, the text being configured to explain content of corresponding visual information.

The term “summary text” refers to a natural-language text generated by a generative information processing model on the basis of at least descriptive text and prompt data, the text including at least advertisement information or additional information related to the visual information or a topic specified by the user.

The term “advertisement information” refers to information related to promotion of goods, services, or content providers, which is included in a summary text for the purpose of presenting commercial or promotional content to a user together with descriptive text and visual information.

The term “additional information” refers to information other than advertisement information that supplements descriptive text, including, for example, explanations, background information, recommended related content, or guidance, which enhances understanding or usability of visual information.

The term “evaluation process” refers to processing in which the processor calculates, for each item of visual information and associated texts, a relevance or suitability measure based on one or more criteria including prompt data, descriptive text, summary text, label information, annotation information, or stored evaluation results.

The term “relevance” refers to a degree of correspondence between visual information and associated texts, on the one hand, and prompt data, user intent, or system-defined criteria, on the other hand, the degree being represented by a score, rank, or classification value used in the evaluation process.

The term “terminal display data” refers to structured data generated by the processor for presentation on a terminal, the structured data including descriptive text, summary text, and references to visual information arranged in a format compatible with display functions and accessibility functions of the terminal.

The term “user support function” refers to a function implemented on the terminal or in cooperation with the terminal, including accessibility support such as audio output or screen reader support, configured to assist a user, including a visually impaired user, in perceiving and understanding displayed content.

The term “audio output function for visually impaired users” refers to a functionality that converts text data such as descriptive text and summary text into audio signals, and outputs the audio signals via a sound output device, thereby allowing visually impaired users to obtain information that is otherwise presented visually.

The term “searchable recording device” refers to a storage apparatus, or a combination of storage apparatuses, configured to store data in an associated manner and to support search processing using keys or indexes, thereby enabling retrieval of stored descriptive texts, summary texts, visual information, prompt data, and evaluation results.

The term “advertisement presentation device” refers to an apparatus or system configured to receive advertisement-related content including visual information, descriptive text, and summary text, and to present the content to users via one or more presentation channels such as display devices, network interfaces, or integrated advertising platforms.

The term “operation history information” refers to data representing past operations performed by a user on a terminal or within a system, including input sequences, selection actions, navigation patterns, or interaction times, which can be analyzed to infer user preferences or emotional state.

The term “biometric information” refers to data related to physiological or behavioral characteristics of a user, such as heart rate, facial expression metrics, voice features, or eye movement patterns, which can be processed to estimate an emotional state of the user.

The term “emotional state” refers to an internal state of a user, such as interest, boredom, excitement, or anxiety, which is estimated by analyzing operation history information, biometric information, or both, and which can be used to adapt tone, amount of information, or presentation order of a summary text.

The term “template of the prompt sentence” refers to a predefined text structure including constant portions and variable insertion portions, which is used by the processor to generate prompt sentences by inserting prompt data, label information, annotation information, or other parameters.

The term “parameter of the evaluation process” refers to a value or set of values controlling behavior of the evaluation process, including, for example, weighting coefficients, threshold values, ranking rules, or feature selection criteria used to compute relevance or to select visual information.

In one embodiment, a server cooperates with one or more terminals operated by users to implement an information processing system that generates, evaluates, and delivers descriptive text, summary text, and associated visual information. The server comprises at least one processor, a main memory, a non-volatile storage device, and a network interface. The processor executes program modules stored in the non-volatile storage device, and the network interface connects the server to a communication network such as the Internet. The terminal comprises a processor, a display device, an input device, an audio output device, a local storage, and a communication interface. The terminal executes a browser or a dedicated application that exchanges data with the server using a communication protocol such as HTTPS over TCP/IP.

The server executes an application program that includes a web server module, an API control module, a prompt generation module, a generative model interface module, an image retrieval module, an image analysis interface module, an evaluation and ranking module, an accessibility formatting module, and a logging and learning module. The non-volatile storage device on the server stores a database that includes at least prompt templates, model configuration parameters, evaluation parameters, user interaction logs, and stored descriptive and summary texts linked to visual information identifiers.

The server uses general-purpose software platforms such as an operating system (for example, a Unix-like operating system), a web framework (for example, a framework executing on a scripting runtime), and a database management system (for example, a relational database or a document database). The server further connects to external services that provide a generative AI model and an image analysis function. The generative AI model has a neural network architecture, such as a transformer architecture with multiple self-attention layers, multi-head attention mechanisms, and position-encoding. The model is configured with parameters including a vocabulary embedding dimension, a number of attention heads, a number of layers, layer normalization parameters, and feed-forward network dimensions. The image analysis function is implemented as a convolutional or transformer-based neural network trained on large-scale image datasets, and provides label information and annotation information in response to image data or image references.

The server uses a generative AI model that has been trained on a large corpus of text using a supervised or self-supervised learning procedure. During training, the server or a training system minimizes a loss function such as a cross-entropy loss between predicted token probabilities and ground-truth tokens. The server or the training system updates model weights using a gradient-based optimization algorithm such as stochastic gradient descent with momentum or adaptive gradient methods. The training procedure may include data augmentation such as random masking of tokens or sequence shuffling to improve generalization. In deployment, the server sets model parameters including maximum sequence length, sampling temperature, top-k or nucleus sampling thresholds, and stop tokens to control output length and variability.

The server constructs prompt sentences for the generative AI model based on prompt data from the user and on annotation information from the image analysis function. The server maintains, in the database, a set of prompt templates that are predefined text patterns with insertion positions for variables. Each template includes constant segments and placeholders for prompt data, label information, and context parameters such as target reading level or tone. The prompt generation module selects an appropriate template according to system configuration, user profile, or usage context and inserts normalized prompt data and image-related annotations into the template.

For example, the server generates a prompt sentence such as:

“You are an assistant that describes visual content for educational purposes. Given the topic ‘ancient Egypt’, generate several concise descriptions of images that could represent this topic, explaining what is shown and its historical significance.”

When annotation information is available for a specific image, the server generates a refined prompt sentence such as:

“Using the following image labels: [‘pyramid’, ‘desert’, ‘ancient architecture’] and the topic ‘ancient Egypt’, generate a clear, one-sentence description of what this image shows and why it is historically important.”

The server further generates prompt sentences for summary text including advertisement or additional information, for example:

“Based on the following description: ‘This is the Great Pyramid of Giza, built as a tomb for an ancient ruler’, generate a short summary that includes additional background information and a suggestion to explore related historical tours, in a neutral and informative tone.”

The server implements the generative model interface module as a client for an external or internal generative AI model service. The module creates a structured request including the prompt sentence, model identifier, maximum token count, and sampling parameters, and transmits the request via the network interface. The server receives token-level probabilities or generated text sequences as a response, and the processor converts the response into descriptive or summary text strings. The server normalizes output text by removing control tokens, trimming whitespace, and splitting long sequences into sentences according to punctuation.

The server implements the image retrieval module to query an external image search service or an internal image repository. The module constructs a search query that includes normalized prompt data and, in some embodiments, key phrases extracted from generative model outputs. The server transmits the search query via the network interface and receives a list of candidate visual information as structured data including URLs, thumbnails, titles, and metadata. The processor converts this structured data into internal data structures such as objects or records that include identifiers, URLs, label fields, and relevance scores initialized to default values.

The server uses the image analysis interface module to analyze each candidate visual item. For each image URL, the server fetches the image data or passes the URL to an external image analysis service. The image analysis service applies a neural network model, for example a convolutional network with multiple convolution and pooling layers followed by fully connected layers or a vision transformer with patch embedding and attention layers, to generate label information and annotation information. The server receives the output as structured data including label names, confidence scores, bounding boxes, or suggested captions. The processor associates this information with the corresponding image object in memory.

The server uses the evaluation and ranking module to compute relevance scores for candidate images. The module constructs feature vectors for each candidate item based on multiple components such as term-frequency or embedding-based similarity between prompt data and labels, similarity between descriptive text and prompt data, and metadata such as origin domain or image resolution. The processor may apply a machine-learning ranking algorithm, such as a gradient boosting machine or logistic regression classifier, trained on past interaction and evaluation results stored in the database. The evaluation module computes a numeric relevance score and updates fields in the candidate image objects. Items with scores below a threshold are removed, and the remaining items are sorted by score.

The server uses the accessibility formatting module to structure descriptive text and summary text into terminal display data that can be effectively processed by user support functions such as screen readers. The module generates a hierarchical data structure containing elements with semantic tags (for example, heading, description, summary, link) and associations between visual items and their corresponding texts. The processor ensures that each descriptive text and summary text is mapped to an accessibility label or alternate text field, so that a terminal-side screen reader can retrieve and vocalize the content without additional interpretation. The server may also include control metadata indicating reading order, grouping of related items, and emphasis markers.

The server employs the logging and learning module to store descriptive texts, summary texts, visual information identifiers, prompt data, evaluation results, and user interaction events in the searchable recording device. For each interaction, the module creates a record that includes fields such as user identifier or session identifier, prompt text, selected items, relevance scores, and user behavior metrics (for example, dwell time or follow-up actions). Periodically, the server reads these records to update parameters of the evaluation and ranking algorithm and to refine prompt templates. For instance, if records indicate that certain templates lead to higher user engagement and lower rejection rates, the server increases a selection weight of those templates. Similarly, the server may re-train or fine-tune the ranking model by using evaluation results as supervision signals.

The terminal operates as a client that interacts with the server. The terminal displays input controls such as text boxes and buttons that allow the user to enter prompt data. The terminal formats user input as textual data and transmits it to the server using JSON or another structured format over HTTPS. When the terminal receives response data including visual information identifiers, URLs, descriptive texts, and summary texts, the terminal parses this data and populates a user interface. The terminal uses a rendering engine (for example, a browser engine or a native UI toolkit) to display images and associated texts on a display device. The terminal further exposes descriptive and summary texts to an accessibility framework of the operating system by setting accessibility labels for UI components. A screen reader on the terminal converts these labels into synthesized speech and outputs the speech via an audio device such as a speaker or headset.

In one example of operation, the user operates the terminal to input the text “ancient Egypt.” The terminal transmits this text as prompt data to the server. The server normalizes the text, selects a template, and generates a prompt sentence such as: “You are an assistant that helps describe visual content about historical topics. Given the topic ‘ancient Egypt’, generate short descriptions of typical images, including pyramids, rulers, and daily life scenes.”

The server sends this prompt sentence to the generative AI model. The model, based on its trained parameters, produces a sequence of tokens that the server decodes into a descriptive list. The server extracts key phrases like “pyramids,” “stone monuments,” and “desert landscapes” and constructs search queries for the image retrieval module. Candidate images are retrieved, and each is analyzed by an image analysis function that returns labels such as “pyramid,” “sand,” “ancient ruins.” The server constructs refined prompt sentences for each image, for example:

“Using the labels [‘pyramid’, ‘sand’, ‘ancient ruins’] and the topic ‘ancient Egypt’, generate one sentence that describes what this image shows and why it is significant.”

The generative model outputs specific descriptions that the server stores as descriptive texts. The server then generates summary texts that incorporate additional information such as references to historical tours or educational content. The evaluation module calculates relevance scores and selects a subset of images and texts. The accessibility formatting module creates structured output so that the terminal can display images and output all texts via a screen reader.

This configuration produces technical effects that go beyond mere automation of human work. By separating prompt data, prompt templates, annotation information, and evaluation results into explicit data structures, and by orchestrating a pipeline in which a generative AI model and an image analysis function are invoked with structured prompt sentences, the server reduces redundant model calls and avoids incoherent or off-topic outputs. Because the server uses learned ranking and template selection based on stored evaluation results, later interactions require fewer candidate generations and network round trips to achieve a desired level of relevance, which reduces processing time and communication load.

The use of annotation information from the image analysis function as explicit features in both prompt construction and relevance evaluation improves the alignment between textual descriptions and visual content. The evaluation module, by computing feature vectors and applying machine-learning ranking algorithms, corrects for biases or noise in search results and generative outputs. This leads to lower error rates in matching images and descriptions, which is a measurable improvement in accuracy compared to simple keyword-based or direct text generation systems.

Furthermore, the server's accessibility formatting module imposes a specific structure on output data that is optimized for screen readers and other user support functions. Instead of leaving interpretation to terminal-side software, the server pre-computes reading order, grouping, and alternate texts, which reduces local processing requirements and decreases latency between receiving data and initiating audio output. The resulting system improves performance and reliability of accessibility functions, particularly on resource-constrained terminals.

The generative AI model processes prompt sentences according to a predetermined architecture and learning procedure. During operation, the server supplies tokenized prompt sentences to the model, which computes attention weights between tokens at each layer, performs matrix multiplications using stored weight matrices, and applies non-linear activation functions. The model produces output token distributions that the server samples according to configured parameters. Because the server controls these internal parameters and uses feedback from evaluation results to adjust template structures and sampling parameters, the system converges toward prompt configurations that minimize unnecessary token generation and reduce output variance that does not improve user-perceived relevance. This technical feedback loop between server-side logging and generative model input improves computational efficiency and model utilization.

The system also employs non-conventional processing rules that differ from typical manual workflows. For example, the server simultaneously uses scores from image labels, textual similarity metrics, and historical interaction metrics in a combined feature space, rather than relying on simple rule-based keyword matching. The server may apply a custom scoring function that weights features according to learned parameters and normalizes scores across different query types. This non-traditional combination of visual and textual features contributes to more robust ranking and selection, leading to faster convergence toward high-quality content sets.

In alternative embodiments, the server may host the generative AI model locally rather than using an external service. In such embodiments, the server includes an accelerator device such as a graphics processing unit or tensor processing unit. The server loads model weights from storage into accelerator memory and executes inference operations locally. The prompt generation and evaluation pipelines remain as described, but network latency between the server and the model is eliminated, further improving response time. In another embodiment, the server uses different generative models for descriptive text and summary text, each tuned or fine-tuned for a specific style or domain. The prompt generation module selects a model according to topic, language, or user profile.

In yet another embodiment, the server performs additional pre-processing on prompt data, such as language detection, synonym expansion, or embedding-based semantic clustering, to choose appropriate templates and search parameters. The evaluation and ranking module may incorporate emotional state estimation by analyzing user operation history or biometric information. When the evaluation indicates a particular emotional state, the server adjusts template selection or summary text tone parameters, which results in dynamically adapted outputs. These adjustments are implemented as numeric changes in evaluation thresholds, template selection probabilities, or sampling parameters, and thus represent technical changes in system behavior controlled by data-driven rules rather than manual editing.

By organizing data structures for prompt templates, feature vectors, relevance scores, and accessibility mappings, and by defining a concrete sequence of machine-executed operations on these data structures, the system provides a technical improvement in how servers generate, manage, and deliver AI-based descriptive and summary texts in conjunction with visual information. The described embodiments achieve reduced processing latency, improved matching accuracy, reduced communication overhead, and enhanced accessibility support compared to conventional approaches that merely link generative models and search services in an unstructured fashion.

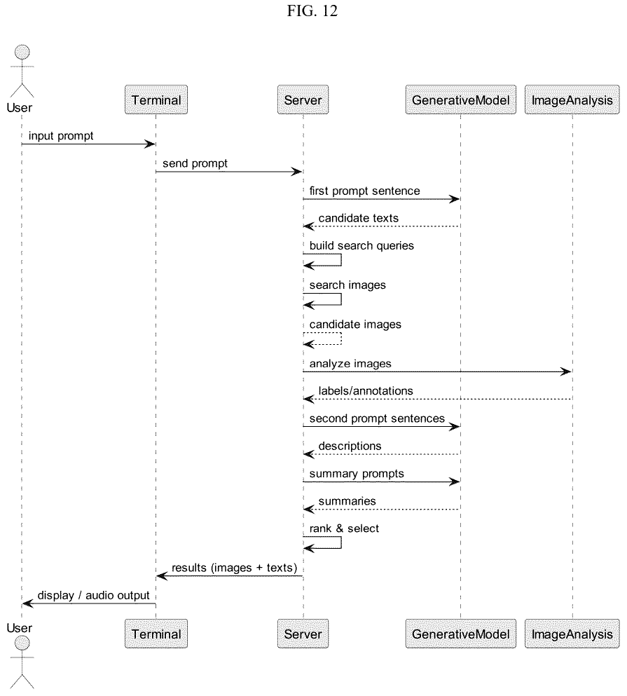

The following describes the processing flow using FIG. 12.
Step 1:

The user operates the terminal to launch an application and to open an input screen that includes a text input field and a submit control. The input of this step is an empty input form on the terminal, and the output is a populated text field containing prompt data such as a topic keyword or sentence (for example, “ancient Egypt”). The user performs a text entry operation via a keyboard or touch interface, and the terminal temporarily stores the entered characters in a local buffer.
Step 2:

The terminal validates the prompt data entered by the user and prepares a transmission request to the server. The input of this step is the raw text string from the local buffer, and the output is a structured request object (for example, a JSON object) ready to be sent to the server. The terminal checks that the string is not empty and that its length is within predefined limits, encodes the string in a character encoding such as UTF-8, attaches metadata such as language code and session identifier, and encapsulates the data into an HTTP request body.
Step 3:

The terminal transmits the structured request containing the prompt data to the server via a communication network. The input of this step is the prepared HTTP request object, and the output is a network packet stream sent to the server's network interface. The terminal uses a protocol stack (for example, HTTPS over TCP/IP) to segment the request into packets, resolve the server address, and send the packets through a communication module such as a Wi-Fi or cellular modem.
Step 4:

The server receives the request from the terminal and parses the contained prompt data. The input of this step is the HTTP request stream arriving at the server's network interface, and the output is an internal prompt data structure stored in server memory. The server's web server module reconstructs the HTTP request, extracts the body, decodes the character data, and converts the JSON fields into variables such as “prompt_text” and “language_code.” The server then logs the raw prompt text together with a timestamp and session identifier into a logging storage.
Step 5:

The server normalizes the prompt data and selects an appropriate prompt template. The input of this step is the raw prompt text string, and the output is a normalized prompt representation and a selected template structure. The server converts characters to a unified case, removes unnecessary whitespace and control characters, and may perform tokenization or language detection. The server uses these normalized features to index into a template table in a database, performing a lookup based on topic category, domain, or language, and retrieves a corresponding template that defines the base structure of a prompt sentence for a generative AI model.
Step 6:

The server generates a first prompt sentence for the generative AI model using the selected template and the normalized prompt data. The input of this step is the template with placeholders and the normalized prompt string, and the output is a complete prompt sentence string. The server executes string substitution operations, inserting the normalized prompt into designated placeholders and, if required, appending control instructions such as target style or length. For example, the server produces a prompt sentence such as: “You are an assistant that helps describe visual content about historical topics. Given the topic ‘ancient Egypt’, generate short descriptions of typical images, including pyramids, rulers, and daily life scenes.”
Step 7:

The server sends the first prompt sentence to the generative AI model and obtains candidate descriptive outputs. The input of this step is the prompt sentence and model configuration parameters (for example, maximum tokens, temperature, and top-k settings), and the output is one or more candidate text sequences representing preliminary descriptions. The server tokenizes the prompt sentence into token IDs using the model's vocabulary, transmits these token IDs and parameters to the model execution environment via an API call, and receives output token probabilities step by step. The server performs decoding (for example, greedy decoding or nucleus sampling) to transform the token probabilities into textual descriptions.
Step 8:

The server extracts key phrases and semantic cues from the candidate descriptions to construct search queries for visual information. The input of this step is the set of candidate descriptive texts, and the output is a set of structured search query strings. The server applies natural-language processing operations such as part-of-speech tagging and keyword extraction, calculates term relevance using measures such as term frequency or embedding similarity to the original prompt, and selects terms with highest relevance scores. The server then concatenates these terms with the original prompt data to generate queries such as “ancient Egypt pyramids image” or “ancient Egypt sphinx photo.”
Step 9:

The server sends the constructed search queries to an image retrieval service and receives candidate visual information. The input of this step is a list of search query strings and retrieval parameters (for example, content type, image size, and safety filters), and the output is a set of candidate visual items with metadata. The server encodes each query in URL parameters, issues HTTP requests to a search API, and receives responses in a structured format that includes image URLs, thumbnail URLs, titles, and short descriptions. The server parses this structured data into internal objects in memory, assigning identifiers and initial relevance scores to each candidate.
Step 10:

The server analyzes each candidate visual item using an image analysis device or service to obtain label and annotation information. The input of this step is the list of candidate image objects with URLs, and the output is the same list enriched with label information and annotation information. The server either fetches the image binary data or passes the URL to an image analysis API, which applies a neural network (for example, a convolutional network or a vision transformer) to infer labels such as object categories and scene types. The server receives labels, confidence scores, and any region-based annotations, and writes these values into fields of the corresponding image objects.
Step 11:

The server generates second prompt sentences for the generative AI model by combining label information, annotation information, and original prompt data. The input of this step is the enriched image objects and the normalized prompt string, and the output is a set of image-specific prompt sentences. For each image object, the server selects a template designed for image-level descriptions, inserts label strings and the topic text into placeholders, and produces a sentence such as: “Using the labels [‘pyramid’, ‘desert’, ‘ancient architecture’] and the topic ‘ancient Egypt’, generate a clear, one-sentence description of what this image shows and why it is historically important.”
Step 12:

The server sends the second prompt sentences to the generative AI model and generates final descriptive texts for each candidate image. The input of this step is the set of second prompt sentences and model parameters, and the output is a mapping from each image identifier to a final descriptive text. The server batches or sequentially sends these prompts to the model interface, receives generated token sequences, decodes them into text, and performs normalization such as punctuation correction and sentence boundary detection. The server then associates each descriptive text with the corresponding image object.
Step 13:

The server generates summary texts that include advertisement or additional information based on descriptive texts and prompt data. The input of this step is the descriptive text for each selected or candidate image and the original or normalized prompt data, and the output is a set of summary texts linked to the same image identifiers. The server constructs summary-oriented prompt sentences, for instance: “Based on the following description: ‘This is the Great Pyramid of Giza, built as a tomb for an ancient ruler’, generate a short summary that includes additional background information and a suggestion to explore related historical tours, in a neutral and informative tone.” The generative AI model returns concise summary sentences, which the server stores as separate text fields in the image objects.
Step 14:

The server evaluates and ranks candidate images using feature vectors that combine prompt data, labels, descriptive texts, summary texts, and historical evaluation parameters. The input of this step is the set of image objects with all associated textual and annotation fields, and the output is an ordered list of image objects with computed relevance scores. The server constructs a feature vector for each image that may include numeric representations of text similarity (for example, cosine similarity in an embedding space between prompt and description), label confidence scores, and previously learned weights. The server applies a ranking model (for example, a gradient boosting classifier) or a scoring function to compute a relevance score and then sorts the images in descending order of score.
Step 15:

The server filters the ranked list to remove low-relevance or duplicate images and selects a final subset for presentation. The input of this step is the ranked list with relevance scores, and the output is a filtered list containing only selected images and their associated descriptive and summary texts. The server applies thresholding rules on scores, removes items with identical or near-identical URLs or titles, and limits the number of items to a target count. The server updates a selection flag in each chosen image object and discards or archives unselected items.
Step 16:

The server structures the selected descriptive and summary texts and visual information into terminal display data optimized for accessibility. The input of this step is the filtered set of image objects with texts, and the output is a structured response payload that includes semantic groupings and accessibility tags. The server constructs a hierarchical representation where each image is linked to a descriptive text and a summary text, assigns roles such as “primary description” and “supplementary summary,” and adds attributes indicating reading order and text type. The server encapsulates this structure into a response format (for example, a JSON document with explicit fields for alt-text and labels) suitable for the terminal's rendering and screen reader frameworks.
Step 17:

The server transmits the structured response payload to the terminal. The input of this step is the prepared data structure for display and accessibility, and the output is an HTTP response that travels through the network to the terminal. The server sets headers such as content type and cache control, serializes the structure into a response body, and sends it using the HTTP protocol. The network interface segments the response into packets, and the communication infrastructure routes the packets to the terminal's communication interface.
Step 18:

The terminal receives the response payload and parses the contained visual information and texts. The input of this step is the HTTP response from the server, and the output is an internal representation of items ready for rendering and accessibility exposure. The terminal's application reads the response body, parses the structured data, and creates UI components or data models that represent each image, descriptive text, and summary text. The terminal also extracts fields designated as accessibility labels or alternate texts and stores them in structures recognized by the operating system's accessibility framework.
Step 19:

The terminal renders the selected visual information and associated texts on the display and exposes them to user support functions. The input of this step is the parsed data models and UI component definitions, and the output is a visual presentation on the display and registered accessibility elements. The terminal downloads image content referenced by URLs, draws the images in image views, and places descriptive and summary texts in text components. The terminal sets accessibility properties so that each text element is associated with a specific image and reading order, enabling a screen reader to traverse the content logically.
Step 20:

The user interacts with the presented content and, if needed, activates or uses accessibility functions such as a screen reader. The input of this step is the rendered interface and registered accessibility elements, and the output is user perception of images and texts, including audio output for visually impaired users. The user scrolls, taps, or navigates via keyboard or touch gestures, and the terminal relays focus changes to the screen reader. The screen reader retrieves the descriptive and summary texts from the accessibility framework and converts them into speech signals that are output via the terminal's audio device, allowing the user to understand the visual content without relying solely on sight.
Step 21:

The server logs interaction and evaluation data for future optimization of prompt templates and ranking parameters. The input of this step is telemetry data from the terminal and internal evaluation results from earlier steps, and the output is updated records in a searchable recording device. The server receives signals such as which items were viewed, how long they remained on screen, and which prompts produced higher engagement. The server writes these signals along with prompt data, chosen templates, and relevance scores into structured log entries. In later maintenance cycles, the server reads these logs to adjust template selection probabilities, ranking model weights, and generative model parameters such as sampling temperature, thereby improving future processing accuracy and efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for generating advertising copy from user-provided descriptions have several technical shortcomings at the level of data processing and human-machine interfaces. In many existing systems, a processor simply forwards raw user text to a generative AI model and returns the model output without performing structured normalization, prompt construction, or post-processing tailored to the constraints of advertising media and accessibility requirements. As a result, the processing pipeline often produces summaries that are excessively long, contain unsuitable expressions, or are inconsistent in quality, which in turn requires manual correction and increases computational and communication overhead due to repeated regeneration requests.

Furthermore, known systems generally do not manage prompt data and generated summaries as structured history information that can be exploited to adapt model selection and summarization conditions over time. Because the processor does not use such history information to optimize subsequent operations, the system fails to reduce unnecessary processing load on remote generative AI resources and cannot systematically improve latency or consistency of outputs.

In addition, conventional interfaces between terminals and servers typically treat the terminal as a simple input-output device and do not offload validation or input assistance processing to the terminal. Raw, unvalidated description information is transmitted to the server, which increases network traffic with poorly structured data, leads to avoidable errors, and requires additional server-side processing to handle malformed or out-of-range inputs.

Moreover, many systems do not tightly integrate generation of accessible output, such as audio signals suitable for visually impaired users, into the same processing flow that generates advertising summaries. Instead, separate and loosely coupled components are used for text-to-speech conversion, resulting in fragmented data paths, duplicated transformations, and inconsistent handling of the generated text across visual and auditory channels.

Accordingly, there is a need for an improved computer-implemented system in which a processor coordinates normalization of user description information, construction of prompt data, interaction with a generative AI model, rule-based post-processing, and generation of content data suitable for both advertising display and speech synthesis, while also using stored history information to adapt processing conditions. Such a system should reduce the computational burden on remote models, improve response time, enhance the quality and consistency of generated summaries, and provide integrated support for accessibility within a unified technical architecture.

The specific processing by the specific processing unit 290 of the data processing device 12 in Example 2 is realized by the following means.

The present invention provides a server comprising a processor configured to acquire, from an information processing terminal, description information related to a product or a service that is input by a user, normalize the description information while extracting feature expressions and context information as targets for summarization, construct a prompt sentence based on the extracted feature expressions and context information, generate prompt data including the prompt sentence specifying summarization conditions for a natural language generation process executed in a generation processing apparatus, obtain, from a generative language model operating on the generation processing apparatus using the prompt data, a summary sentence that expresses the description information in a concise form suitable for an advertising medium, determine, for the obtained summary sentence, a length, content expression, and presence or absence of inappropriate terms in accordance with predetermined rules, modify or correct the summary sentence in accordance with a determination result, generate content data including the modified or corrected summary sentence in a format that is transmittable to an advertising display processing apparatus and an audio output apparatus, provide the content data to the information processing terminal, and store, in a storage device, history information including the prompt data and the summary sentence and update, based on the history information, at least one of a model selection condition and a summarization condition for a subsequent summarization process. This enables technical improvements in computer operation by structuring input normalization and prompt construction to reduce unnecessary token processing by the generative language model, by performing deterministic rule-based post-processing to stabilize output length and content for machine handling, by generating unified content data consumable by both visual display and speech synthesis pipelines without redundant transformation, and by adaptively controlling subsequent model selection and summarization parameters based on stored history information, thereby improving processing efficiency, reducing network and computation overhead, and providing more consistent, accessible advertising summaries within a single integrated system architecture.

The term “processor” refers to a hardware or virtual computation unit, such as a central processing unit, graphics processing unit, or dedicated processing circuitry, that executes machine-readable instructions to perform data processing operations defined by a program.

The term “information processing terminal” refers to an electronic device, such as a mobile device, personal computer, or embedded device, that includes at least an input interface, a display interface, and a communication interface, and is configured to transmit and receive data to and from a server or other processing apparatus.

The term “description information” refers to text data or equivalent symbolic data representing an explanation of a product, a service, or related content, which is input by a user for the purpose of generating an advertising-oriented summary.

The term “normalize” refers to processing that converts input data into a standardized internal representation, including at least one of removing redundant characters, unifying character encodings, adjusting spacing or line breaks, and converting variants of expressions into a predefined canonical form.

The term “feature expressions” refers to words, phrases, or symbol sequences extracted from the description information that indicate main attributes, advantages, or characteristics of the product or service.

The term “context information” refers to information indicating relationships among feature expressions, surrounding textual environment, semantic roles, or usage situations derived from the description information.

The term “summarization conditions” refers to constraints or control parameters for a summarization process, including at least one of target length, style, tone, level of detail, target audience, or medium type.

The term “prompt sentence” refers to natural-language text or equivalent instruction data that specifies summarization conditions and provides the generative AI model with instructions on how to transform the description information into a summary sentence.

The term “prompt data” refers to structured data that includes at least the prompt sentence and may further include associated metadata, such as language information, target medium, or user identification information, and that is used as input to a generative AI model.

The term “generation processing apparatus” refers to a computing environment, which may include one or more servers, virtual machines, or cloud resources, that executes a generative AI model or associated natural language generation components.

The term “generative language model” refers to a trained machine learning model configured to generate natural-language text, including a neural network model that produces output text tokens based on input tokens such as a prompt sentence.

The term “summary sentence” refers to a natural-language sentence or short text sequence generated from the description information under the summarization conditions, which concisely expresses the essential content of the description information.

The term “advertising medium” refers to any medium capable of presenting advertising content, including at least one of a web page, an application screen, a digital signage display, an electronic mail message, or an audio broadcast.

The term “predetermined rules” refers to conditions or procedures defined in advance by configuration data, program code, or rule sets, which specify how to evaluate and, if necessary, modify or correct a summary sentence.

The term “inappropriate terms” refers to expressions that violate predetermined criteria, including at least one of offensive language, discriminatory expressions, prohibited industry terms, or undesired stylistic elements.

The term “content data” refers to data formatted for delivery to output devices, including at least the summary sentence and optionally additional metadata, layout information, or tags for use by an advertising display processing apparatus or an audio output apparatus.

The term “advertising display processing apparatus” refers to an electronic device or system configured to receive content data and control visual display of advertising information on a display unit.

The term “audio output apparatus” refers to an electronic device or system configured to output audio signals via a speaker, headphone, or equivalent transducer, based on input audio data or text-to-speech output.

The term “speech synthesis processing apparatus” refers to a hardware and software configuration that converts text data, such as the summary sentence, into an audio signal using a text-to-speech algorithm or similar processing.

The term “history information” refers to stored data sets including at least prompt data and corresponding summary sentences, and optionally additional metadata such as timestamps, user identifiers, or evaluation results, used to analyze and optimize subsequent processing.

The term “model selection condition” refers to criteria used to select one generative language model or one configuration of a generative language model from among a plurality of candidates, based on factors such as content type, length, or previous performance.

The term “summarization condition” refers to a particular instance of summarization parameters, such as length limit, target style, or level of detail, applied during a specific summarization operation and possibly updated based on history information.

The term “storage device” refers to a physical or virtual memory component, such as a magnetic disk, solid-state drive, non-volatile memory, or distributed storage system, configured to store programs, configuration data, and history information for later retrieval and processing.

In one embodiment, a server, a terminal, and a user cooperate to implement the claimed system. The server includes at least one processor, a main memory, a non-volatile storage device, and a network interface. The terminal includes at least one processor, a memory, a display device, an input device, an audio output device, and a communication interface. The user operates the terminal to input description information and to consume summary sentences generated by the server.

The server executes system software such as a general-purpose operating system (for example, a Linux-based operating system) and middleware such as a web application framework (for example, a framework corresponding to Flask, FastAPI, or Express). The server further executes an application program implementing prompt construction, interaction with a generative AI model, rule-based post-processing, content data generation, and history management. The terminal executes an operating system for mobile or desktop use (for example, a mobile operating system or a desktop operating system) and an application program that provides a graphical user interface, input assistance processing, and output control for both visual display and audio.

The terminal acquires description information by presenting one or more text input components on the display device. The user inputs product-related or service-related text through a keyboard, a touch panel, or a voice input interface. The terminal stores the description information in a local memory buffer and may additionally store it in a local database such as a relational or key-value store. The terminal performs local normalization of the description information, for example by removing extra whitespace, unifying character encoding to a specified internal format, and converting certain punctuation marks to a canonical form using string-processing functionalities of the programming language runtime.

The terminal analyzes the normalized description information to extract feature expressions and context information. The terminal uses a text processing module that applies tokenization, part-of-speech tagging, and simple pattern-matching rules. For example, the terminal splits the text into tokens based on whitespace and punctuation, identifies noun phrases and adjective phrases as potential feature expressions, and detects surrounding verbs and prepositional phrases as context information indicating usage scenes or target users. The terminal may use a lightweight language processing library that implements these operations via deterministic finite state machines and statistical taggers, thereby reducing the computational load on the server.

The terminal constructs a prompt sentence based on the extracted feature expressions and context information. The terminal retrieves a prompt template stored in local configuration, inserts the normalized description information, and optionally appends explicit instructions reflecting summarization conditions such as maximum length, tone, and target medium. In one example, the terminal generates the following prompt sentence:

“You are an assistant that creates clear, concise ad copy. Please summarize the following product or service description in one sentence suitable for an advertisement. Focus on the main benefits and maintain an accessible tone that can be understood easily by a wide audience, including visually impaired users who will hear this via text-to-speech: ‘This shampoo uses organic ingredients and is gentle on hair. It is designed for daily use and helps maintain a healthy scalp.’”

In another example, the terminal generates the following prompt sentence:

“Please summarize the following product description in one concise English sentence suitable for an online advertisement, focusing on its main benefits and accessibility: ‘This shampoo uses organic ingredients and is gentle on hair. It is designed for daily use and helps maintain a healthy scalp.’”

The terminal encapsulates the prompt sentence and related metadata, such as a target output length parameter and an identifier of a generative language model class, into prompt data structured in memory. The terminal then transmits the prompt data to the server via the communication interface using a secure network protocol.

The server receives the prompt data and stores it temporarily in main memory. The server parses the prompt data into internal data structures, such as an object including fields for the prompt sentence, language code, length constraint, and target medium type. The server passes the prompt sentence and associated parameters to a generative AI model executed in a generation processing apparatus. In one embodiment, the generation processing apparatus is implemented as a hardware accelerator cluster accessible via a network API, and the generative AI model is implemented as a transformer-based neural network language model. The generative AI model includes a plurality of layers, each layer including a multi-head self-attention sub-layer and a feed-forward sub-layer. The model parameters include token embedding matrices, positional encodings, attention weight matrices, and feed-forward network weights. The model receives the prompt sentence tokenized into a sequence of subword units, converts the sequence into a sequence of embedding vectors, and then propagates the vectors through the transformer layers. The attention mechanism computes attention scores for each pair of token positions using scaled dot-products, and generates context vectors for each token based on the attention scores. The feed-forward sub-layers apply non-linear transformations such as rectified linear unit or similar activation functions to produce intermediate representations. The final layer outputs a probability distribution over vocabulary tokens for each position in the generated summary sentence.

The generative AI model is trained in advance using a large corpus of text data. A training procedure minimizes a loss function such as cross-entropy between predicted token distributions and ground-truth token sequences. A gradient-based optimization algorithm such as stochastic gradient descent with momentum or adaptive learning rate methods updates the model weights. The training may use data augmentation techniques, such as random masking, word order shuffling within constraints, or synthetic paraphrase generation, to increase robustness of the summarization behavior. By performing this training, the generative AI model learns to map prompt sentences and description-like inputs to coherent summary sentences that satisfy length and content constraints specified in the prompts.

The server configures the generative AI model with specific parameters for summarization, such as a maximum number of output tokens, a sampling temperature, and a presence penalty, before requesting the summary sentence. By controlling these parameters, the server constrains the computational path through the model, reduces unnecessary token generation, and thereby improves response time and reduces hardware utilization.

The server receives an output sequence of tokens corresponding to a summary sentence from the generative AI model and converts the tokens back to a text string using a decoder associated with the tokenizer. The server then performs rule-based post-processing on the summary sentence. The server applies a set of predetermined rules stored in configuration tables. These rules may include a maximum character count limit, a check for specific prohibited substrings, replacement rules for certain phrases, and normalization of punctuation. The server uses regular expressions and deterministic state machines to scan the summary sentence and apply modifications when conditions are satisfied.

The server, for example, removes excessive exclamation marks, truncates the sentence if it exceeds a defined character threshold, and replaces detected prohibited words with alternative terms or neutral expressions. The server also calculates a quality indicator, such as a length score and a content compliance score, based on rule evaluations. Because these operations are deterministic and optimized for string processing, the server can guarantee that all summary sentences comply with advertising and accessibility constraints without re-invoking the generative AI model, thus reducing model calls and network traffic.

The server generates content data by combining the modified or corrected summary sentence with metadata such as language, target playback rate for speech synthesis, and display preferences. The server formats the content data in accordance with an internal schema optimized for fast parsing by the terminal. The server stores the prompt data and corresponding summary sentences as history information in a storage device, such as a non-volatile database. The server associates each history entry with timestamps, identifiers of the generative AI model variant used, and post-processing results.

The server analyzes the accumulated history information periodically or upon certain triggers. The server computes performance metrics such as average response time, average number of tokens generated, and frequency of rule-based corrections. The server adjusts model selection conditions based on these metrics. For example, the server may select a smaller generative language model for short, simple descriptions when history information indicates that the smaller model meets quality thresholds, thereby lowering computational cost and latency. Conversely, the server may select a larger model for complex descriptions when history information indicates that the smaller model frequently generates summaries requiring extensive correction. The server also adjusts summarization conditions such as maximum token counts and temperature values based on observed error patterns. Through these feedback mechanisms, the server improves the efficiency and stability of the summarization pipeline over time.

The terminal receives the content data from the server and parses the structure into the summary sentence and its attributes. The terminal displays the summary sentence on the display device using user interface components provided by a graphical toolkit. The terminal adjusts font size, color, and layout in accordance with the metadata, and with user settings, to meet accessibility guidelines. The user can review the summary sentence, and the terminal provides interaction elements allowing the user to accept, reject, or annotate the summary sentence.

The terminal also generates an audio representation of the summary sentence to support visually impaired users. The terminal passes the summary sentence text and audio parameters included in the content data to a speech synthesis processing apparatus. The speech synthesis processing apparatus may be implemented using a text-to-speech engine installed on the terminal or accessed from a remote service. The speech synthesis processing apparatus converts the summary sentence into an intermediate phonetic representation, such as a sequence of phonemes or syllables, using a grapheme-to-phoneme conversion algorithm. The apparatus then generates an audio waveform using a synthesis algorithm such as concatenative synthesis, parametric synthesis, or neural vocoder-based synthesis.

The terminal receives the audio signal as a digital waveform and outputs it through the audio output device, such as a built-in speaker or a connected headset. The terminal integrates with system-level accessibility functions, including screen readers and gesture-based controls, to allow the user to start, pause, or repeat playback. By using the same content data for both visual display and audio output, the terminal avoids duplicative formatting logic and ensures consistency between what is displayed and what is spoken.

In another embodiment, the server performs at least part of the speech synthesis. The server inputs the summary sentence into a neural text-to-speech model that uses an encoder-decoder architecture with attention, or a sequence-to-sequence architecture with a neural vocoder. The model converts text into mel-spectrogram features and then synthesizes time-domain waveforms using a generative model. The server returns the compressed audio data, such as a waveform audio file, to the terminal as part of the content data. This configuration can reduce processing load on terminals with limited computing resources and ensure consistent audio quality across different terminal types.

The terminal executes input assistance processing and format check processing before sending description information to the server. For example, the terminal counts the number of characters and lines and checks whether required fields are present. If the description information does not satisfy predefined conditions such as a minimum character length or permitted character set, the terminal displays re-input prompting messages and may highlight problematic portions. This reduces transmission of malformed or incomplete descriptions to the server, thereby decreasing server-side error handling and improving overall throughput.

The described architecture produces technical effects beyond mere automation of human copywriting. By offloading initial normalization and simple feature extraction to the terminal, the system reduces the volume and variability of data that must be processed by the server and the generative AI model, which in turn reduces network bandwidth usage and average latency. By constructing structured prompt data that explicitly encodes summarization conditions, the system allows the generative AI model to operate under constrained token budgets, reducing unnecessary computation in deep neural layers. By applying deterministic post-processing rules on the server, the system guarantees compliance with length and content constraints without repeatedly invoking the generative AI model, which further reduces computational cost and API traffic.

Moreover, by storing and analyzing history information including prompt data and generated summaries, the server continuously calibrates model selection and parameter settings based on observed performance. This feedback loop improves model utilization efficiency and stability of output quality in a way that manual human procedures cannot readily achieve. The combination of specific data structures (prompt data, content data, history records), rule-based algorithms, and adaptive control of generative model parameters yields an improvement in computer functionality, including faster average response time, reduced error rates due to malformed input, and optimized use of computational resources in the generation processing apparatus.

In yet another embodiment, the server employs multiple generative language models with different architectures or sizes, such as small and large transformer configurations. The server stores, in the history information, mappings between input complexity measures (for example, token count, vocabulary diversity, and syntactic depth) and model performance metrics. The server computes these complexity measures for new description information and uses a trained decision function, such as a logistic regression or decision tree classifier, to select an appropriate generative language model before summarization. This selective routing of requests among multiple models further enhances technical efficiency by matching computational resources to the complexity of the task.

The user can apply the generated summary sentences and associated audio signals to various advertising media. However, the core contribution of the system lies not in the advertising workflow itself but in the specific configuration and interaction of the server, the terminal, and the generative AI model, including the defined data structures, neural network architecture, training procedures, and rule-based algorithms that together improve the way computers process, generate, and deliver summaries in an accessible and computationally efficient manner.

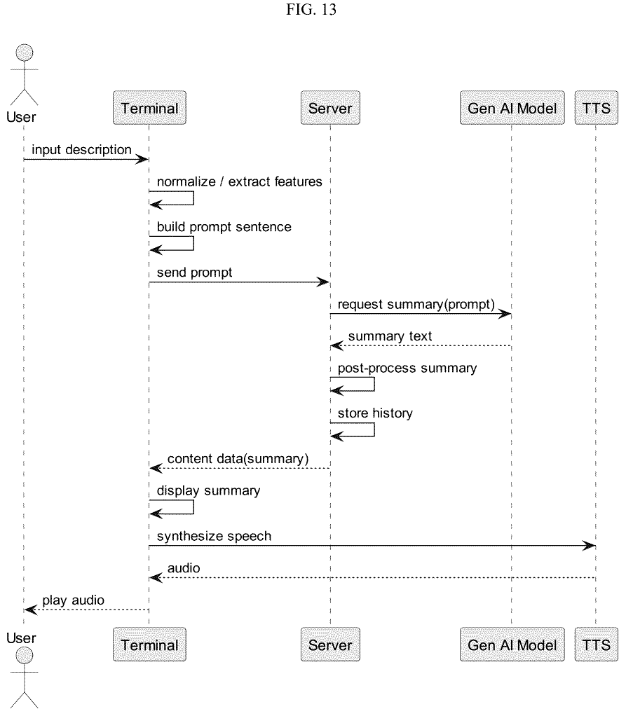

The following describes the processing flow using FIG. 13.
Step 1:

The user inputs description information into the terminal.

The user operates the terminal's input interface (for example, a touch keyboard or physical keyboard) and enters free-form text describing a product or service. As input, the terminal receives raw character sequences including letters, spaces, punctuation, and line breaks. The terminal stores this raw text in a memory buffer. Based on this input, the terminal verifies basic conditions such as presence of required fields and minimum character length by counting characters and checking for empty strings. As output of this step, the terminal maintains validated raw description information ready for further processing.
Step 2:

The terminal normalizes the description information.

The terminal takes the validated raw description text as input and applies a series of string transformations. The terminal removes leading and trailing whitespace, collapses multiple spaces into a single space, unifies line break codes, and converts characters into a standardized encoding (for example, UTF-8) using built-in string manipulation functions. The terminal may replace variant punctuation (for example, different quotation mark types) with canonical symbols by table lookup. Using these operations, the terminal produces normalized description information as output, represented as a cleaned text string suitable for linguistic analysis.
Step 3:

The terminal performs local linguistic analysis and extracts feature expressions and context information.

The terminal receives the normalized description information as input and tokenizes the text into words or subwords by splitting on spaces and punctuation using a tokenizer module. The terminal then applies part-of-speech tagging or heuristic rules to identify nouns, noun phrases, adjectives, and verb phrases. The terminal designates nouns and associated adjectives as feature expressions and interprets surrounding verbs and prepositional phrases as context information, such as usage scenarios or target users. The terminal computes frequency counts and simple statistics (for example, token frequency and sentence length) over these tokens. As output, the terminal produces structured analysis data including a list of feature expressions, a representation of context information, and the normalized text.
Step 4:

The terminal constructs a prompt sentence based on the extracted information.

The terminal uses the structured analysis data as input, including the list of feature expressions, the context information, and the normalized description text. The terminal selects an appropriate prompt template from a configuration store, for example a template specifying sentence length and tone. The terminal programmatically inserts the normalized text and, optionally, explicit constraints (such as “in one concise sentence” or “for visually impaired users via text-to-speech”) into the template using string concatenation and placeholder substitution. The terminal may also encode parameters such as maximum length or target medium as embedded instructions in the natural-language text. As output, the terminal generates a complete prompt sentence, such as: “Please summarize the following product description in one concise English sentence suitable for an online advertisement, focusing on its main benefits and accessibility: ‘This shampoo uses organic ingredients and is gentle on hair. It is designed for daily use and helps maintain a healthy scalp.’”
Step 5:

The terminal assembles prompt data and transmits it to the server.

The terminal takes the prompt sentence and related metadata (such as language code, user identifier, and desired summary length) as input. The terminal constructs prompt data as a structured object in memory with fields for the prompt sentence and the metadata. The terminal then serializes this object through a data encoding process, and uses the communication interface to send the serialized prompt data to the server over a secure channel. As output, the terminal produces a network request containing the prompt data that arrives at the server for processing.
Step 6:

The server receives the prompt data and parses it into internal structures.

The server takes the incoming network request containing the prompt data as input. The server uses a network stack and an application framework to parse the request, decode the serialized payload, and reconstruct the structured prompt data object in main memory. The server verifies the integrity and completeness of the prompt data by checking required fields and length limits. The server may log this data by writing selected fields (for example, prompt sentence and user identifier) into a storage device. As output, the server maintains in memory a validated prompt data structure ready to be passed to a generative AI model.
Step 7:

The server prepares a generative AI model request using the prompt data.

The server receives the validated prompt data as input and extracts the prompt sentence and control parameters such as target length or tone indicators. The server selects a generative language model configuration based on stored model selection rules and, optionally, prior history information (for example, a smaller or larger model depending on expected complexity). The server constructs a model request object that includes tokenization settings, maximum output token count, sampling temperature, and penalties for repetition. The server then maps the prompt sentence into a sequence of token identifiers using a tokenizer associated with the generative AI model. As output, the server produces a fully specified model request, including tokenized prompt data and parameter settings, ready to be processed by the generation processing apparatus.
Step 8:

The server invokes the generative AI model to generate a summary sentence.

The server takes the model request as input and forwards the tokenized prompt and parameters to the generative AI model running on a generation processing apparatus. Inside the model, the sequence of tokens is converted into embedding vectors using an embedding matrix, and then processed through multiple layers of a transformer architecture. Each layer performs data operations including matrix multiplications, attention score calculations, and non-linear activation functions. The model computes, for each output position, a probability distribution over possible next tokens and samples or selects tokens according to the configured parameters. The server receives, as output from the model, a sequence of generated token identifiers corresponding to a summary sentence that concisely represents the original description information under the specified conditions.
Step 9:

The server decodes the generated tokens and performs rule-based post-processing.

The server takes the generated token sequence as input and converts the tokens back into a text string using a decoder that maps token identifiers to characters or subwords. The server then applies deterministic rule-based processing to this text. The server checks the length of the summary by counting characters and tokens, evaluates content using pattern matching to detect prohibited or disfavored terms, and normalizes punctuation and spacing. The server applies transformations such as truncation beyond a maximum character count, replacement of disallowed words with acceptable alternatives, and removal of redundant punctuation. These operations involve string comparisons, regular expression matching, and substring replacement. As output, the server produces a modified or corrected summary sentence that conforms to predefined length and content constraints.
Step 10:

The server generates content data and updates history information.

The server receives the corrected summary sentence as input and combines it with metadata such as creation time, model identifier, language settings, and accessibility flags. The server constructs content data as an internal object including the summary sentence and control attributes for display and audio output. The server also creates or updates a history record that stores the original prompt data, the raw model output (if stored), the corrected summary sentence, and quality indicators such as length and rule-violation counts. The server writes this history record into a storage device using database insertion or update operations. As output, the server obtains content data ready for delivery to the terminal and updated history information for later analysis.
Step 11:

The server transmits the content data to the terminal.

The server takes the content data as input and serializes it into a response format. The server uses the network interface to send the serialized content data back to the terminal via a response message. The server may also include processing metrics such as elapsed time or version information. As output, the terminal receives a network response containing the content data including the summary sentence and associated control parameters.
Step 12:

The terminal parses the content data and controls visual display of the summary sentence.

The terminal takes the received content data as input and deserializes it into a local data structure containing the summary sentence and metadata. The terminal configures its graphical user interface based on the metadata, adjusting font size, color, and layout to meet accessibility preferences. The terminal writes the summary sentence into a text display component and refreshes the display. The terminal may also highlight certain feature expressions by applying style attributes to substrings. As output, the terminal presents the summary sentence visually to the user on the display device.
Step 13:

The terminal generates and outputs speech for the summary sentence.

The terminal takes the summary sentence and audio-related parameters from the content data as input. The terminal transfers this text to a speech synthesis processing apparatus via an application programming interface. The speech synthesis apparatus converts the input text into a phonetic representation and then into a time-domain audio waveform using digital signal processing and, in some embodiments, a neural vocoder model. The terminal receives the resulting digital audio signal and forwards it to the audio output device using an audio driver. The terminal may also register playback control with system-level accessibility services so that the user can operate playback by gestures or keyboard shortcuts. As output, the terminal produces an audible rendering of the summary sentence through the speaker or headphones for the user, including a visually impaired user.
Step 14:

The server analyzes history information and adjusts model selection and summarization conditions.

The server periodically or on demand takes accumulated history information stored in the storage device as input. The server computes aggregated metrics such as average summary length, distribution of rule violations, and average response time per model configuration by performing database queries and arithmetic operations. The server applies a decision algorithm, such as a threshold-based rule set or a trained classifier, to determine whether to adjust model selection conditions or summarization parameters. For example, the server may lower maximum output tokens or select a smaller model variant for cases where history shows consistent over-length summaries. The server writes updated configuration values back to a configuration store. As output, the server maintains adapted model selection rules and summarization conditions that will be used as input for future processing, thereby improving computational efficiency and stability of the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation and advertising systems that utilize machine learning models suffer from several technical limitations in how they process user input and generate multimodal output. First, such systems typically handle prompt sentences from users as simple text strings and pass them directly to a generative AI model without structured analysis or integration with visual information. As a result, the systems are unable to consistently associate generated text with specific visual information in a machine-tractable way, and cannot reliably generate coherent image description text and advertising summaries that are tightly coupled to the actual image content.

Second, existing systems generally do not maintain a unified processing pipeline from prompt sentence acquisition, through image retrieval and image analysis, through text generation and adaptation, to structured embedding of the generated text into document attributes and media data. This leads to fragmented implementations where each stage (e.g., image search, caption generation, ad copy writing, alt-text generation) is handled by separate components, requiring multiple network round trips and manual intervention. Such fragmentation increases latency, reduces throughput, and complicates error handling and logging at the system level.

Third, conventional systems do not efficiently exploit emotional context in a technically integrated manner. Emotion analysis, if present, is often treated as a separate analytics feature and is not fed back into the generative AI pipeline as a control signal that modifies the prompts and thereby the model output. Consequently, the computing system cannot adapt the tone, level of detail, and style of generated image descriptions or summary texts based on a user's inferred emotional state, which results in suboptimal personalization and requires additional, ad hoc post-processing on the client side.

Fourth, accessibility support, particularly for visually impaired users, is commonly implemented as a thin layer on top of existing content. Alt text is often manually authored or trivially derived from file names or limited metadata, and is not generated by a coordinated process that combines prompt analysis, visual analysis, and generative AI. This produces low-quality alternative text that does not accurately describe the underlying visual information, and forces screen readers and audio output devices to work with incomplete or inconsistent data structures, thereby degrading the technical performance of accessibility features.

Accordingly, there is a need for an improved computer-implemented system that: (i) systematically analyzes prompt sentences as structured input data; (ii) retrieves or generates related visual information and analyzes it to produce machine-usable explanation data; (iii) uses a generative AI model in a coordinated way to generate both image description text and advertising summary text; (iv) programmatically embeds the generated text into structured document attributes and image data; (v) technically integrates emotion analysis as a control signal to adjust the prompts and generated outputs; and (vi) converts and associates the generated summary text with visual information in a format optimized for downstream speech synthesis. By addressing these technical issues in the end-to-end data flow, the computing system can reduce processing steps, improve consistency between text and images, improve accessibility for visually impaired users, and enhance the overall performance and reliability of server-side content generation and delivery.

The specific processing by the specific processing unit 290 of the data processing device 12 in Application Example 2 is realized by the following means.

The present invention provides a server comprising a processor, the processor being configured to acquire prompt data input by a user via a terminal as structured input for a generative AI model, to analyze the prompt data by natural language processing to extract information items, and to obtain related visual information by search processing or generation processing on the basis of the extracted information items and analyze the visual information by image analysis processing to generate explanation data including label information or feature information, to supply the prompt data and the explanation data as input data to the generative AI model and generate, by the generative AI model, image description text that describes contents of the visual information, to supply the image description text and attribute information that an information providing entity desires to add as input data to the generative AI model and generate, by the generative AI model, summary text applicable to an advertising medium, to set the summary text as alternative text for the visual information in attribute information of a structured document or to add the summary text as display control information to image data so that the summary text is superimposed on the visual information, to store the summary text and the visual information in a form usable for audio output processing in an output device and transmit the summary text and the visual information to an advertising display device or an information providing device, and to execute emotion analysis processing for estimating an emotional state on the basis of user input data, operation history data, or sensing data and adjust prompt data for the generative AI model according to the estimated emotional state so as to change a tone, an expression, or an information amount of the generated image description text or the summary text, and to convert the summary text into text data in a format usable as input to a speech synthesis device and store the text data in association with the visual information in a data storage device and transmit response data including the text data to the terminal. This enables an integrated server-side processing pipeline that technically improves how prompt sentences are interpreted, how visual information is retrieved and analyzed, how generative AI outputs are controlled and embedded into structured data, and how emotion-adaptive and accessibility-oriented summaries are produced and delivered, thereby enhancing processing efficiency, consistency between modalities, personalization based on emotional context, and the quality and reliability of audio output for visually impaired users.

The term “processor” refers to a hardware computation unit, or a combination of hardware computation units, that executes machine-readable instructions, and includes, for example, a central processing unit, a graphics processing unit, a digital signal processor, or a programmable logic device.

The term “terminal” refers to an information processing apparatus operated by a user to input data and receive output from a server, and includes, for example, a mobile communication device, a personal computer, a tablet device, or a similar user interface device.

The term “user” refers to an entity, such as an individual or an organization, that operates a terminal to input data, including prompt data, and to receive generated content or services from the system.

The term “prompt data” refers to text data or equivalent structured input provided by a user to instruct a generative AI model to execute a specific processing task, such as generating a description, a summary, or other natural language output.

The term “prompt sentence” refers to a particular form of prompt data expressed as one or more natural language sentences that specify a desired operation or output for the generative AI model.

The term “generative AI model” refers to an artificial intelligence model configured to generate output data, such as natural language text or other modalities, in response to input data, and includes, for example, a probabilistic language model, a neural network model, or a transformer-based model.

The term “natural language processing” refers to a class of computational techniques for analyzing, interpreting, and transforming human language text, including operations such as tokenization, part-of-speech tagging, entity extraction, and syntactic or semantic analysis.

The term “information items” refers to structured elements of meaning extracted from prompt data, such as keywords, entities, attributes, categories, or other semantic units used to control downstream processing.

The term “visual information” refers to machine-processable data representing visual content, including, for example, still images, moving images, graphics, or other pixel-based or vector-based data.

The term “search processing” refers to a computational procedure that retrieves visual information or other data from a storage device or an external resource based on one or more search conditions derived from input data.

The term “generation processing” refers to a computational procedure that creates new data, including visual information or text data, using an algorithmic model such as a generative AI model, without relying solely on retrieval of existing stored data.

The term “image analysis processing” refers to a set of computational operations applied to visual information to extract machine-usable data, including, for example, object detection, label assignment, feature extraction, or optical character recognition.

The term “explanation data” refers to structured data generated from visual information by image analysis processing, the structured data including label information, feature information, or other descriptors that represent contents of the visual information.

The term “label information” refers to one or more categorical identifiers or tags assigned to visual information to indicate concepts, objects, scenes, or attributes detected in the visual information.

The term “feature information” refers to numerical or symbolic descriptors extracted from visual information, such as edges, shapes, colors, regions, or higher-level features, which are used to characterize the visual information.

The term “image description text” refers to natural language text generated by a generative AI model that verbally describes the contents of visual information based on prompt data and explanation data.

The term “information providing entity” refers to a party that supplies information to be reflected in generated text, such as an advertiser, a content provider, or another entity wishing to add attributes or constraints to the generated output.

The term “attribute information” refers to structured metadata specifying properties or constraints associated with content, such as desired emphasis points, tone, target audience, or additional details to be included in a generated text.

The term “summary text” refers to natural language text generated by a generative AI model that concisely represents main points of image description text or related information, and that is adapted for use in an advertising medium or similar output context.

The term “advertising medium” refers to any medium configured to present advertising information to users, including, for example, network-based advertising spaces, application-based placements, or display devices for commercial information.

The term “structured document” refers to a digital document that includes syntactic or semantic markup defining elements and their attributes, and includes, for example, a markup language document, a hypertext document, or another document with machine-readable structure.

The term “alternative text” refers to text data associated with visual information in a structured document to describe the contents of the visual information for use in display substitution, accessibility processing, or indexing.

The term “display control information” refers to information that specifies how content, including text, is to be displayed on or in association with visual information, including position, style, or layering rules for superimposing text on an image.

The term “image data” refers to digital data representing an image, including pixel values, color information, and related metadata, which can be processed for display or further analysis.

The term “audio output processing” refers to a sequence of computational operations that convert text data or other symbolic data into audible signals for output through an audio transducer.

The term “output device” refers to a device configured to present information to a user, including, for example, a display device, a speaker, a headset, or another peripheral that outputs visual or audio signals.

The term “advertising display device” refers to an output device or a combination of devices configured to present advertising content to users, such as a display panel, a terminal running an advertisement application, or a network-connected signage system.

The term “information providing device” refers to a device or system configured to deliver information content, including generated text and visual information, to users or other systems over a communication network.

The term “emotion analysis processing” refers to a set of computational procedures that analyze input data, such as user text, operation history, or sensing data, to estimate an emotional state of a user.

The term “emotional state” refers to a representation of a user's affective condition, such as joy, sadness, anger, or neutrality, expressed as a label, score, or other machine-usable indicator.

The term “operation history data” refers to stored data representing past operations performed by a user on a terminal or system, such as input sequences, selection actions, browsing behavior, or other interaction logs.

The term “sensing data” refers to data acquired from one or more sensors associated with a terminal, such as camera data, microphone data, motion sensor data, or biometric readings, which can be used to infer user context or emotional state.

The term “tone” refers to stylistic characteristics of generated text, such as a level of formality, positivity, enthusiasm, calmness, or other qualitative attributes of expression.

The term “expression” refers to specific wording, phrase selection, and stylistic choices used in generated text to convey information or emotion.

The term “information amount” refers to a degree of detail or quantity of information included in generated text, such as the number of mentioned features, level of explanation, or text length.

The term “speech synthesis device” refers to a hardware or software system configured to convert text data into audio signals representing spoken language.

The term “text data” refers to machine-readable data expressed in a character encoding that represents symbols, words, or sentences, and that can be processed by a speech synthesis device or other text-processing components.

The term “data storage device” refers to a memory or storage apparatus, such as a semiconductor memory, a magnetic storage medium, or an optical storage medium, configured to store data including visual information and associated text data.

The term “response data” refers to data generated by a server and transmitted to a terminal in reply to a request, the data including at least generated text, such as summary text, and optionally references to associated visual information.

In one embodiment, a server cooperates with one or more terminals operated by users to implement the claimed system. The server includes at least one processor, a main memory, a non-volatile storage device, and a network interface. The processor may include a central processing unit and one or more graphics processing units optimized for matrix and tensor operations. The server executes a plurality of software modules, including a prompt analysis module, an image retrieval and analysis module, a generative AI inference module, an emotion analysis module, a text embedding and accessibility module, and a data management module. The terminals may be mobile communication devices, personal computers, or tablet devices executing a web browser or a native application that communicates with the server over a network using a secure protocol.

The terminal provides a user interface through which a user inputs prompt sentences as natural language instructions. The terminal may display an input field where the user types a prompt sentence such as “Based on the following product features, generate an attractive advertising summary. Features: high-performance camera, long-lasting battery, stylish design.” or “Summarize the features of the latest smartphone in one or two sentences for use as alt text for a web image.” The terminal may also display controls for uploading or selecting images and for submitting additional attribute information that an information providing entity desires to add, such as target audience or emphasis level. The terminal transmits the prompt sentence and any associated data to the server as structured request data using a defined message format.

The server executes the prompt analysis module to convert the received prompt sentence into an internal data structure suitable for downstream processing. The server stores the prompt text in a character-encoded format and performs tokenization, part-of-speech tagging, and named entity recognition using a natural language processing library. The server represents the result as a data structure containing a sequence of tokens, token-level tags, and extracted information items such as product category, feature descriptors, and requested tone. For example, from the prompt sentence “high-performance camera, long-lasting battery, stylish design,” the server creates a structured record with fields corresponding to “camera feature,” “battery feature,” and “design feature.” This structured representation reduces ambiguity and enables efficient indexing and reuse of prompt information across different processing modules, which improves processing speed and reduces error propagation compared to passing raw text between modules.

The server executes the image retrieval and analysis module to obtain visual information related to the extracted information items. The server may query an internal image repository or an external image source using search keys derived from the information items. The server stores candidate image metadata in a structured index and applies a scoring algorithm that considers feature overlap, textual similarity, and historical selection data. The server selects one or more images and normalizes them to a standard resolution and color space. The server then performs image analysis processing using a trained convolutional neural network configured for object detection, scene classification, and attribute extraction. The network may include convolutional layers, pooling layers, and fully connected layers that output label information and feature vectors for each image. The server represents the analysis result as explanation data that includes label information, such as “smartphone,” “person,” or “beach,” and feature information, such as color histograms or high-level embedding vectors. By converting heterogeneous image data into compact, structured explanation data, the server reduces the amount of data transferred to the generative AI inference module and enables faster similarity computations and better alignment between text and images.

The server executes the generative AI inference module to generate image description text and summary text based on the prompt data and the explanation data. In one embodiment, the server employs a generative AI model implemented as a transformer-based neural network with multiple self-attention layers, feedforward layers, and layer normalization. The model is trained on large corpora of paired text and image-related descriptions, using a training objective that predicts the next token in a sequence conditioned on previous tokens and, optionally, on image-derived feature vectors. During training, the server calculates a loss function, such as cross-entropy between predicted token probabilities and ground truth tokens, and updates model parameters by backpropagation and stochastic gradient descent or an adaptive optimization algorithm. The server may also perform data augmentation by paraphrasing training sentences, randomly masking tokens, and sampling alternative image-text pairs to improve generalization and robustness.

At inference time, the server converts the tokenized prompt data and selected label information into a combined input sequence for the generative AI model. The server may prepend system-level instructions that define the model's role, such as “You are an advertising copywriter. Generate a concise description of the product shown in the image using the following features.” The server concatenates the user's prompt tokens and additional tokens representing label information or compressed feature vectors. The generative AI model processes this combined sequence and computes output token probabilities at each decoding step using multi-head self-attention and cross-attention to the encoded context. The server selects the next token using a controlled sampling strategy, such as top-k sampling or nucleus sampling, constrained by maximum token length and forbidden token sets. This specific architecture and decoding procedure improve the coherence and relevance of the generated image description text, and reduce redundant or inconsistent phrases that often occur in simpler rule-based or template-based approaches.

The server generates image description text that directly reflects both the prompt sentence and the visual information. For example, given explanation data that includes labels “smartphone” and “camera lens,” and the prompt sentence about high-performance camera and long-lasting battery, the server may obtain image description text such as “A modern smartphone with a prominent camera module designed for high-quality photography and extended daily use.” The server stores this image description text in association with the corresponding visual information and prompt record in the data management module.

The server further generates summary text adapted for advertising use by reusing the same generative AI model with a different conditioning context. The server constructs an internal instruction string, such as “Rewrite the following description as a short, catchy advertising summary in one or two sentences.” and appends the previously generated image description text. The generative AI model then produces summary text that is more concise and persuasive. For example, the server may obtain “Capture every moment in stunning detail and stay powered all day with this sleek smartphone.” By controlling the input instruction and context, the server systematically transforms descriptive text into advertising-oriented text in a single inference pipeline, which improves computational efficiency and avoids separate rule-based post-processing stages.

The server executes the emotion analysis module to estimate a user's emotional state based on user input data, operation history data, or sensing data. The server may apply a text-based emotion classifier implemented as a neural network trained on labeled sentiment data, where the input consists of token embeddings of recent user messages and the output consists of emotion scores, such as probabilities for joy, neutrality, or sadness. The server may also process sensing data, such as image frames captured by a terminal camera or audio segments from a microphone, using separate neural networks configured for facial expression analysis or prosody analysis. The server fuses these multiple emotion estimates using a weighted averaging or learned fusion model to produce a final emotional state representation. This representation is stored alongside the user's current session data and is used as a control signal to adjust subsequent generative AI processing.

The server modifies the prompts sent to the generative AI model based on the estimated emotional state. The server adds or replaces specific tokens that encode tone directives, such as “in a calm and reassuring tone” or “in an enthusiastic and uplifting tone,” and may adjust the maximum length or level of detail requested. This non-trivial adjustment of model inputs at the token level uses quantitative emotion scores as control parameters and results in systematic variation of output style. For example, when the emotion analysis module indicates joy, the server may request “a positive, exciting advertising summary,” whereas when the module indicates sadness, the server may request “a gentle, encouraging advertising summary that avoids aggressive language.” Because the server controls the generative AI model through structured, contextualized prompts rather than simple post-editing, the system reduces the need for multiple re-generation attempts and produces more consistent outputs with fewer network round trips and less computation overall.

The server executes the text embedding and accessibility module to embed the generated summary text into structured document attributes and image data. The server constructs a markup document or document fragment in which an image element is associated with an alternative text attribute containing the summary text. The server further applies an image processing library to superimpose the summary text on the visual information, calculating text position, line breaks, and contrast to maintain readability in different display resolutions. The server stores the resulting image data and structured document in a storage device, with metadata that links them to the relevant user session, campaign identifier, and emotion state. This consistent embedding of text into both structural attributes and visual layers enables terminals and assistive technologies to retrieve machine-readable descriptions and present them in visual or audio form without additional manual configuration.

The server converts the summary text into text data in a format suitable for speech synthesis processing. The server ensures that the text uses a standardized character encoding and optionally inserts prosodic annotations, such as pause markers or emphasis tags, based on punctuation and syntactic structure. The server stores this text data in association with the corresponding visual information so that, when a terminal requests details for a specific image, the server can return a compact payload that includes identifiers for the image, the alternative text, and the speech-ready text data. This organization minimizes communication load by avoiding redundant textual data transfer and supports fast retrieval for repeated requests.

The terminal receives the structured response from the server and integrates it into its local user interface. The terminal displays the adapted advertising image and may present the summary text on-screen. The terminal also registers the alternative text and speech-ready text with a local operating system accessibility framework so that a screen reader or other speech synthesis device can access it directly. When a visually impaired user interacts with the image, the terminal retrieves the corresponding text data and invokes a speech synthesis engine to generate audible output. Because the summary text has been produced by a coordinated pipeline that includes prompt analysis, image analysis, generative AI processing, emotion adjustment, and structured embedding, the terminal is able to output more accurate and context-appropriate descriptions than would be possible with generic alt text.

In another embodiment, the server processes prompt sentences for purely text-based product descriptions without any associated image. The server applies similar prompt analysis and generative AI procedures to generate an advertising summary suitable for future association with visual information. The server may then store this summary as part of a catalog entry and later link it to image data retrieved or generated at a later time. This decoupled mode allows independent optimization of text and image resources while preserving the ability to compute emotion-adaptive and accessibility-oriented outputs when they are ultimately combined.

In yet another embodiment, the server executes the generative AI inference module on specialized hardware that includes one or more graphics processing units. The server batches multiple prompt requests and explanation data items into a single computational graph, which reduces per-request overhead and improves throughput. The server may quantize model parameters or use mixed-precision arithmetic to accelerate matrix multiplications and reduce memory bandwidth consumption while keeping degradation of output quality within an acceptable tolerance. The server monitors latency and adjusts batch sizes and decoding parameters dynamically to meet service-level requirements, thereby achieving a technical improvement in processing speed and resource utilization compared to naïve sequential processing.

In a further embodiment, the server uses a modular data flow architecture in which each module communicates through well-defined structured records rather than unstructured strings. The prompt analysis module outputs a record containing token arrays, entity lists, and feature flags. The image analysis module outputs label vectors and feature tensors. The emotion analysis module outputs emotion score arrays. The generative AI inference module consumes these records and produces text token sequences with associated likelihoods. This modular design allows the server to cache intermediate results, detect anomalies at specific stages, and implement fine-grained load balancing across hardware resources. These properties improve the reliability and maintainability of the system, and reduce the risk of cascading failures caused by malformed or ambiguous data.

The server thus performs a sequence of tightly integrated technical operations that go beyond simply automating human tasks. The server transforms user prompt sentences into structured representations; fuses them with machine-derived visual features; drives a specific neural network architecture through carefully crafted prompt conditioning; applies quantitative emotion signals as control parameters; and embeds results into machine-readable attributes optimized for downstream display and audio output. These operations improve alignment between modalities, reduce processing time and network usage through reuse of intermediate representations, and enhance accessibility for visually impaired users. Because the system is implemented as a coordinated set of software modules on specialized hardware and uses concrete neural network architectures, training methods, and data structures, the invention provides a specific technological solution that improves the functioning of computer-based content generation and delivery systems.

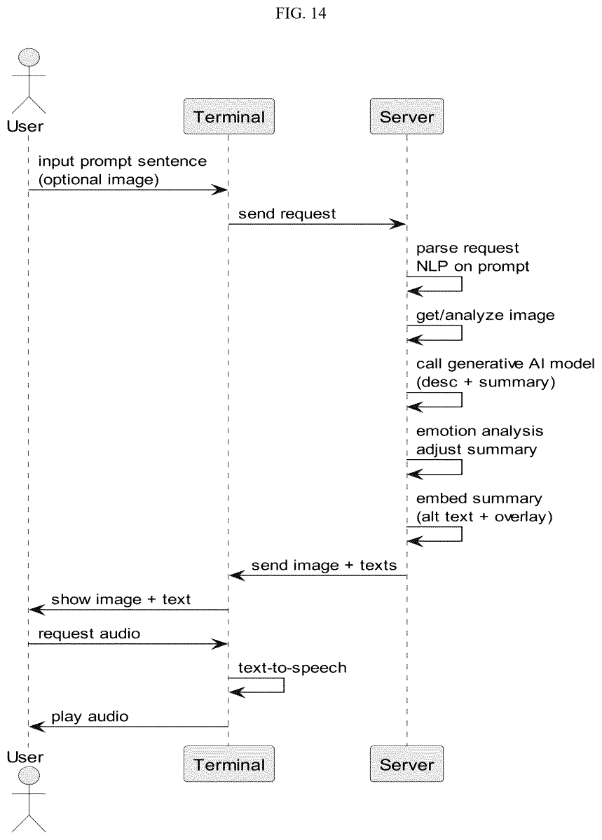

The following describes the processing flow using FIG. 14.
Step 1:

User operates the terminal to input a prompt sentence and optional image.

User opens an application or web page on the terminal and types a prompt sentence such as “Based on the following product features, generate an attractive advertising summary. Features: high-performance camera, long-lasting battery, stylish design.” or “Summarize the features of the latest smartphone in one or two sentences for use as alt text for a web image.” User may also select or upload an image file to be associated with the prompt sentence and optionally specify additional attribute information such as target audience or preferred tone.

Input: raw natural language text (prompt sentence), optional image file, optional attribute information.

Output: a structured request object inside the terminal containing fields for prompt text, image data or image reference, and attribute metadata.

Terminal converts the input into a defined internal structure, performs basic validation (e.g., text length, file type, file size), and stores the structure in memory ready for transmission.
Step 2:

Terminal transmits the structured request to the server.

Terminal serializes the structured request object into a message format (for example, a key-value representation) and sends it to the server via a network using a secure protocol. Terminal attaches authentication information such as a user identifier or session token.

Input: internal structured request object in the terminal.

Output: a network message delivered to the server that contains prompt text, image data or reference, and attribute information.

Terminal waits for a response asynchronously, managing a request identifier to match future responses.
Step 3:

Server receives and parses the request from the terminal.

Server listens on a network interface and accepts the incoming message. Server stores the raw message in a request log storage for traceability and then parses the message to extract the prompt sentence, image data or reference, and attribute metadata.

Input: network message from the terminal.

Output: an internal server-side data record that includes prompt text, user identifier, optional image representation, and attribute fields.

Server performs character encoding normalization, removes control characters, and checks that mandatory fields are present. Server then inserts the parsed data into an in-memory or temporary database record for access by downstream modules.
Step 4:

Server analyzes the prompt sentence by natural language processing.

Server passes the prompt text to a prompt analysis module that performs tokenization, part-of-speech tagging, and entity recognition. Server generates a sequence of tokens and identifies key information items such as product type, feature list, requested tone, and intended output length.

Input: raw prompt sentence as a text string.

Output: a structured prompt representation containing a token array, part-of-speech tags, entity list, and extracted information items.

Server uses these extracted items to construct search queries and control parameters for the generative AI model, reducing ambiguity and enabling deterministic behavior in later modules.
Step 5:

Server retrieves or generates visual information based on extracted information items.

Server examines the structured prompt representation to determine whether to use an existing image or to search for or generate a new one. If an image reference is provided, server retrieves the image from storage. If no image is provided or image search is requested, server creates a search query using product names and feature keywords and sends the query to an internal or external image repository.

Input: structured prompt representation and optional image reference.

Output: normalized image data representing selected visual information and associated image metadata.

Server applies a selection algorithm that scores candidate images based on keyword overlap and past relevance metrics, chooses the highest-scoring image, and converts it to a standard resolution and color format for analysis.
Step 6:

Server performs image analysis to generate explanation data.

Server feeds the normalized image data into an image analysis module that uses a trained neural network (for example, a convolution-based classifier and detector) to identify objects, scenes, and attributes. Server receives label scores and feature vectors from the model and selects labels whose scores exceed predetermined thresholds.

Input: normalized image data.

Output: explanation data consisting of label information, feature information, and confidence scores.

Server constructs a compact data structure that maps each selected label to its confidence score and associates it with a feature vector representing high-level visual characteristics. This structure is stored with the request record and provided to the generative AI module.
Step 7:

Server prepares combined input for the generative AI model.

Server creates a combined context that includes system-level instructions, the original prompt sentence, extracted information items, and label information from the explanation data. Server arranges these elements into a single ordered sequence suitable for a transformer-based generative AI model, marking boundaries with control tokens that indicate role (system, user, visual context).

Input: structured prompt representation and explanation data.

Output: a combined model input sequence including tokenized text and, where supported, encoded feature vectors.

Server encodes the text tokens into embeddings and, if the model supports multimodal input, encodes the image feature vector into a compatible embedding space for use in cross-attention layers.
Step 8:

Server generates image description text using the generative AI model.

Server passes the combined input sequence to the generative AI model and initiates inference with specified decoding parameters, such as maximum output length, temperature, and sampling method. The model processes the input through multiple attention and feedforward layers to compute token probability distributions for each output time step.

Input: combined model input sequence derived from the prompt and explanation data.

Output: image description text represented as a sequence of generated tokens and a final text string.

Server selects output tokens sequentially according to the probability distributions, joins them into a text string, and post-processes the string to remove incomplete sentences, extra whitespace, or disallowed symbols.
Step 9:

Server generates advertising-oriented summary text from the image description text.

Server constructs a new conditioning prompt that instructs the generative AI model to rewrite the image description text as concise advertising copy. Server provides the image description text as context and applies an output length constraint to enforce short, impactful sentences.

Input: image description text and an instruction specifying advertising style and length constraints.

Output: advertising summary text suitable for overlay on images and use as alt text.

Server runs the generative AI model again with this specialized instruction and the image description context, then validates the result by checking the inclusion of required feature terms and ensuring that the text does not exceed predetermined character limits.
Step 10:

Server estimates the user's emotional state.

Server collects user input data (recent prompt sentences, feedback phrases, emoticons) and, if available, operation history data or sensing data from the terminal (such as interaction speed or captured audio/visual cues). Server normalizes and vectorizes this data and passes it through one or more emotion classifiers configured to output emotion scores.

Input: user text snippets, interaction logs, and optional sensor-derived features.

Output: an emotion state representation for the user session, such as numerical scores for multiple emotion categories and a selected dominant emotion label.

Server stores this emotion state in the session record and marks it with a timestamp so that it can be referenced when generating or adjusting text outputs.
Step 11:

Server adjusts the summary text based on the estimated emotional state.

Server uses the emotion state representation to modify the prompt instructions given to the generative AI model. For example, if the emotion label is “joy,” server appends a directive requesting an enthusiastic and positive tone; if the label is “sadness,” server appends a directive requesting a calm and reassuring tone. Server then passes the previously generated summary text and the modified instruction back into the generative AI model for controlled rewriting.

Input: initial advertising summary text and emotion state representation.

Output: emotion-adjusted summary text with a tone and level of detail tailored to the user's emotional state.

Server compares the adjusted text to predefined style rules and filters out undesirable patterns, then selects the final version for embedding.
Step 12:

Server embeds the summary text into structural attributes and image data.

Server constructs or modifies a structured document element (for example, a markup element) that references the selected image and sets an attribute for alternative text to the final summary text. Server also calls an image-processing routine that renders the summary text as a visual overlay on the image, calculating an appropriate position, font, and color to ensure readability.

Input: final emotion-adjusted summary text and normalized image data.

Output: structured document data with alternative text set and updated image data with superimposed text.

Server writes the attribute text and overlay image to storage, associating them with identifiers for retrieval and further use by terminals and other devices.
Step 13:

Server prepares and transmits response data for display and audio output.

Server gathers identifiers or file references for the updated image, the alternative text, and any speech-prepared text version and packages them into a response structure. Server compresses large binary data if necessary and transmits the structure to the terminal using the network interface.

Input: stored structured document fragment, overlay image reference, and summary text data.

Output: a response message to the terminal containing references and text content ready for display and speech synthesis.

Server may also register the content in an advertising display subsystem or information delivery subsystem for broader distribution.
Step 14:

Terminal receives the response and updates the user interface.

Terminal parses the response message, retrieves or caches the referenced image, and integrates the alternative text into its local accessibility framework. Terminal renders the advertising image with the overlaid text on its display according to layout rules and may show the summary text below or beside the image.

Input: response message from the server.

Output: updated user interface state including displayed images and stored alternative text accessible by local components.

Terminal binds the alternative text to accessibility hooks so that assistive software can request and consume it.
Step 15:

Terminal outputs the summary text as speech for visually impaired users.

Terminal detects user interaction events that indicate a need for audio description, such as focus changes in a screen reader mode or gestures on the image. Terminal retrieves the alternative text or emotion-adjusted summary text linked with the image and forwards it to a local or remote speech synthesis engine.

Input: alternative text associated with the displayed image and a trigger event from user interaction.

Output: synthesized speech output that audibly conveys the summary text to the user.

Terminal plays the synthesized audio through the device's speaker or a connected audio output device, enabling the user to understand the advertising content or visual information without needing to see the image.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

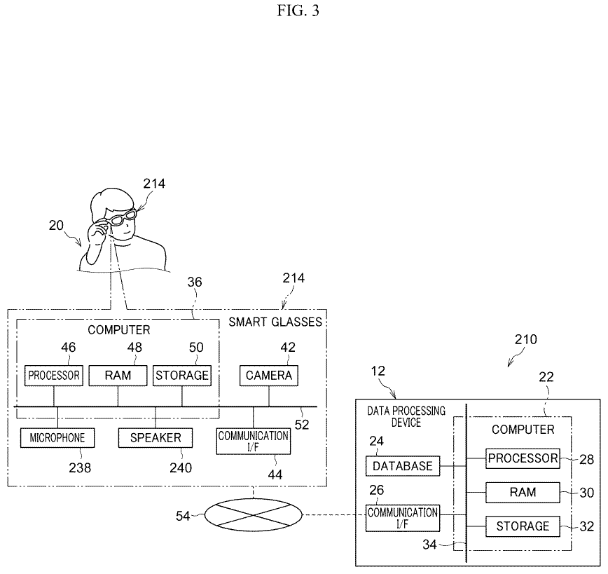

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

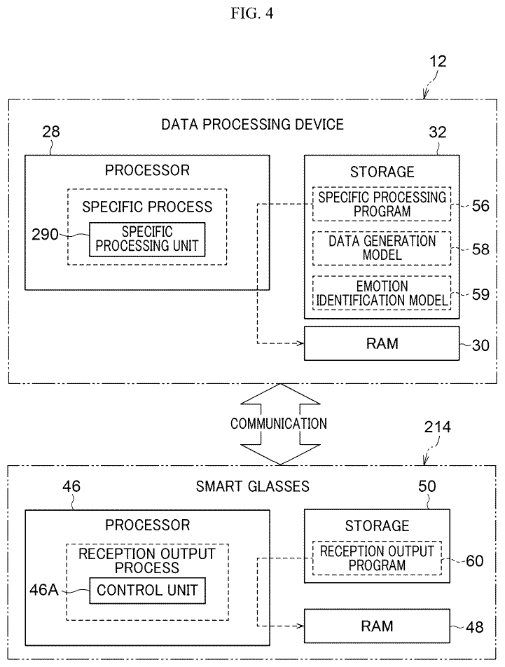

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

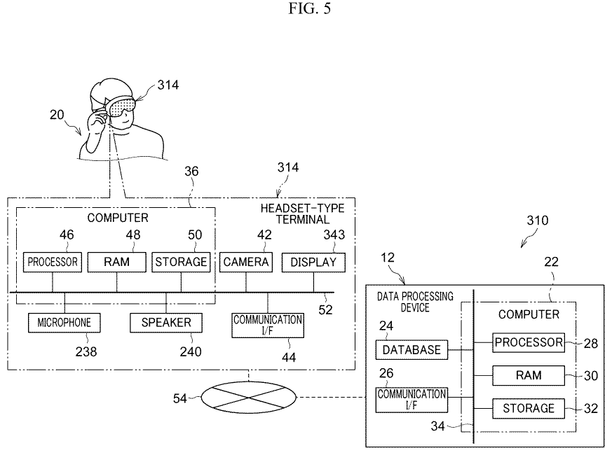

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

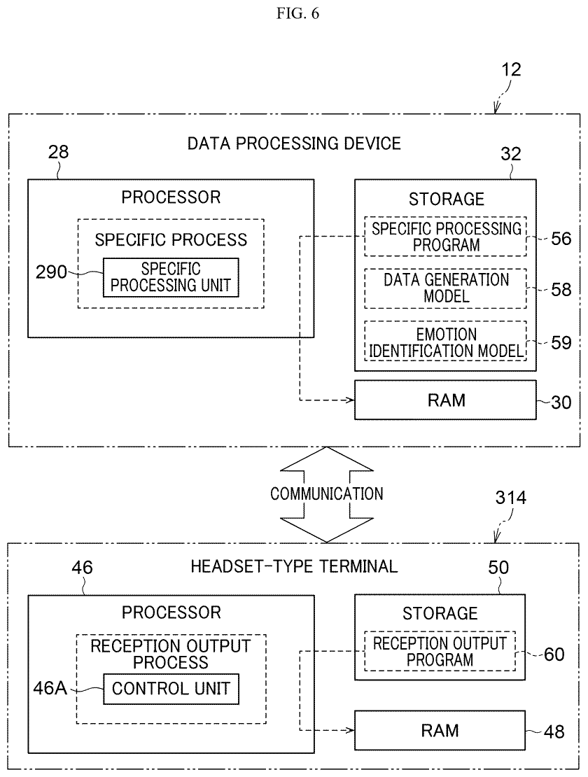

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

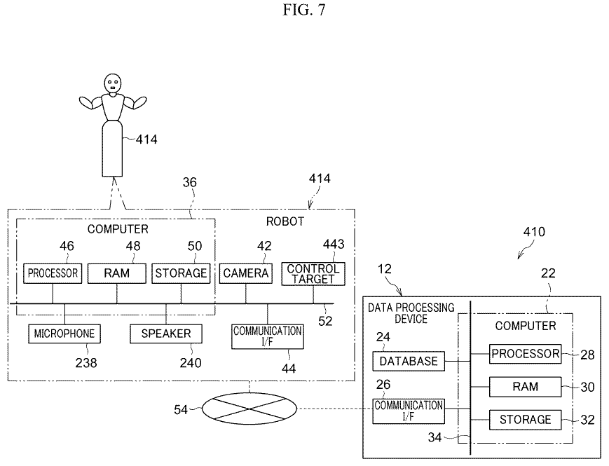

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

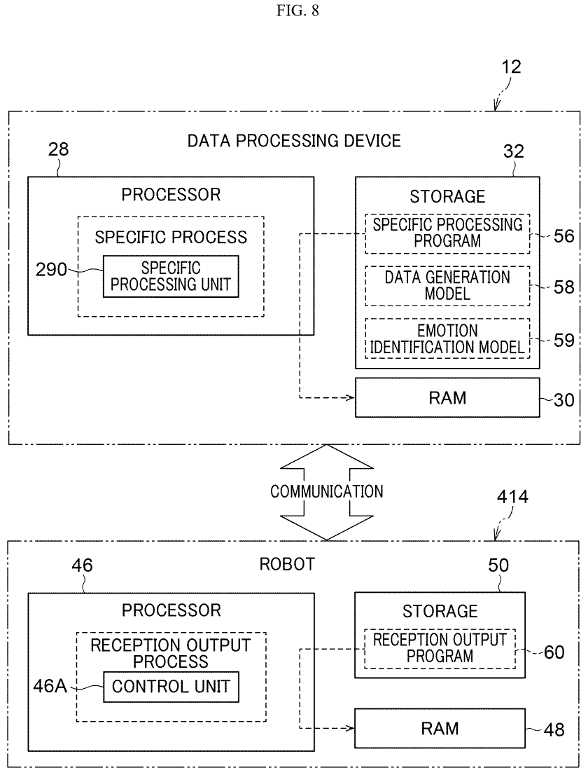

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

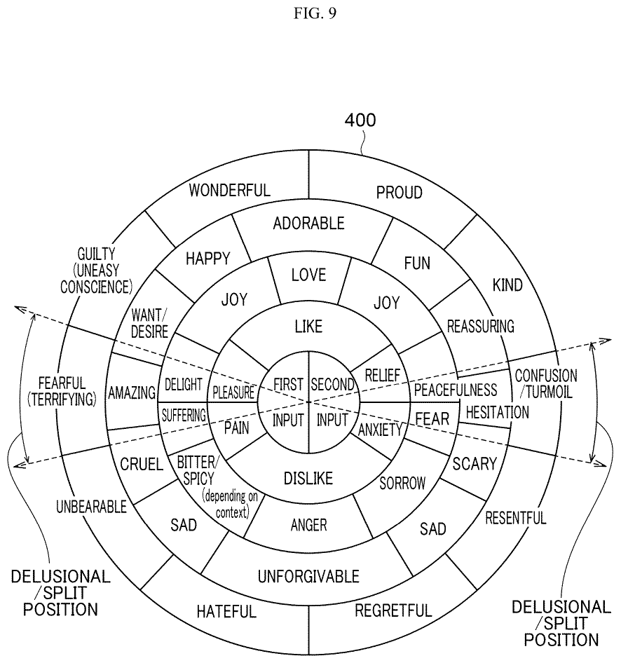

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

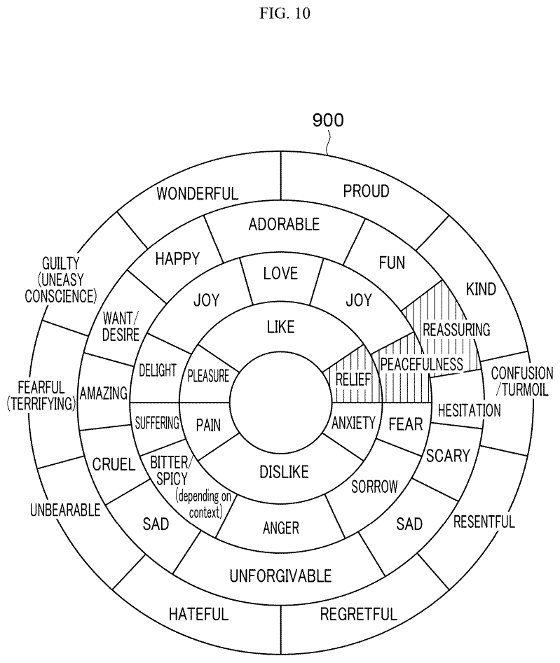

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal operated by a user, prompt data that is input by the user for instructing a generative AI model to execute a specific processing operation, and analyze the prompt data by a natural language processing unit so as to extract search terms, search for visual information through an external information source on a basis of the extracted search terms, and select visual information from a plurality of pieces of acquired visual information in accordance with a predetermined criterion,
input the selected visual information to an image analysis unit and acquire an analysis result including object information and scene information from the image analysis unit,
integrate the analysis result as structured data and generate a prompt sentence for input to the generative AI model on a basis of the integrated structured data,
cause the generative AI model to execute a natural language generation process by using the generated prompt sentence so as to generate an explanation sentence describing content of the visual information,
cause the generative AI model to execute a natural language generation process so as to generate a summary sentence in which advertisement information stored in an advertisement information storage unit is incorporated in a natural manner on a basis of the explanation sentence and the advertisement information, and
configure the summary sentence and the visual information as search result display data and transmit the search result display data to the terminal.

### (Supplementary 2)

The system according to supplementary 1,
wherein the processor is configured to
analyze user operation history information or user state information acquired from the terminal to estimate an emotional state of the user, and adjust at least one of a prompt sentence for the generative AI model and a style, a length, or an emphasis content of the generated summary sentence in accordance with the estimated emotional state.

### (Supplementary 3)

The system according to supplementary 1,
wherein the processor is configured to
store the generated explanation sentence and the generated summary sentence, and
corresponding visual information, in association with identification information in an information storage unit, and configure the stored explanation sentence, the stored summary sentence, and the corresponding visual information as distribution data that is transmittable to an advertisement distribution processing apparatus.

### Application Example 1

### (Supplementary 1)

A system comprising a processor,
wherein the processor is configured to
receive, via a terminal operated by a user, prompt data for instructing a generative information processing model to execute predetermined information processing, and analyze the prompt data,
generate, based on the analyzed prompt data, a prompt sentence constructed from a template sentence including the prompt data, cause the generative information processing model to process the prompt sentence, and acquire, via an information retrieval device, candidate visual information related to the prompt data from a network,
obtain, for each item of the candidate visual information, label information or annotation information by using an image analysis device, and generate, by inputting a prompt sentence including the label information or the annotation information and the prompt data into the generative information processing model, a descriptive text that explains content of the visual information,
generate, based on the descriptive text and the prompt data, a summary text including advertisement information or additional information by using the generative information processing model,
perform an evaluation process on the descriptive text, the summary text, and the visual information based on relevance, select visual information according to a result of the evaluation process, and transmit the selected visual information and corresponding descriptive text and summary text to the terminal, and
structure the descriptive text and the summary text as terminal display data so that the descriptive text and the summary text transmitted to the terminal are outputtable as audio information by a user support function including an audio output function for visually impaired users.

### (Supplementary 2)

The system according to supplementary 1,
wherein the processor is configured to
analyze operation history information or biometric information of the user to estimate an emotional state of the user, and adjust a tone, an amount of information, or a presentation order of the summary text in accordance with the emotional state.

### (Supplementary 3)

The system according to supplementary 1,
wherein the processor is configured to
store the descriptive text, the summary text, the visual information, the prompt data, and an evaluation result obtained in the evaluation process in an associated manner in a searchable recording device, update a template of the prompt sentence to be input to the generative information processing model or a parameter of the evaluation process based on the stored information, and transmit the descriptive text, the summary text, and the visual information to an advertisement presentation device.

### Example 2

### (Supplementary 1)

A system comprising a processor,
wherein the processor is configured to
acquire description information related to a product or a service, the description information being input by a user via an information processing terminal, and normalize the description information while extracting feature expressions and context information as targets for summarization,
construct a prompt sentence, based on the extracted feature expressions and context information, the prompt sentence specifying summarization conditions for a natural language generation process executed in a generation processing apparatus, and generate prompt data including the prompt sentence,
obtain, from a generative language model operating on the generation processing apparatus and using the generated prompt data, a summary sentence that expresses the description information in a concise form suitable for an advertising medium,
determine, for the obtained summary sentence, a length, content expression, and presence or absence of inappropriate terms in accordance with predetermined rules, and modify or correct the summary sentence in accordance with a determination result,
generate content data including the modified or corrected summary sentence in a format that is transmittable to an advertising display processing apparatus and an audio output apparatus, and provide the content data to the information processing terminal, and
control display of the summary sentence included in the content data on the information processing terminal, and further input the summary sentence to a speech synthesis processing apparatus to generate an audio signal, and output the summary sentence auditorily to a user including a visually impaired user.

### (Supplementary 2)

The system according to supplementary 1,
wherein the processor is configured to
execute input assistance processing and format check processing on the description information, determine whether the description information satisfies a predetermined character count range and format condition, and, when the description information does not satisfy the condition, control display of re-input prompting information to the user on the information processing terminal.

### (Supplementary 3)

The system according to supplementary 1,
wherein the processor is configured to
store, in a storage device, history information including the prompt data and the summary sentence, and update, based on the history information, at least one of a model selection condition and a summarization condition for a subsequent summarization process.

### Application Example 2

### (Supplementary 1)

A system comprising a processor,
wherein the processor is configured to
acquire prompt data input by a user via a terminal, the prompt data being used for instructing a generative AI model to execute a specific process, and analyze the prompt data by natural language processing to extract information items,
obtain related visual information by search processing or generation processing on the basis of the extracted information items, and analyze the visual information by image analysis processing to generate explanation data including label information or feature information,
supply the prompt data and the explanation data as input data to the generative AI model and generate, by the generative AI model, an image description text that describes contents of the visual information,
supply the image description text and attribute information that an information providing entity desires to add as input data to the generative AI model and generate, by the generative AI model, a summary text applicable to an advertising medium,
set the summary text as alternative text for the visual information in attribute information of a structured document, or add the summary text as display control information to image data so that the summary text is superimposed on the visual information, and
store the summary text and the visual information in a form usable for audio output processing in an output device, and transmit the summary text and the visual information to an advertising display device or an information providing device.

### (Supplementary 2)

The system according to supplementary 1,
wherein the processor is configured to execute emotion analysis processing for estimating an emotional state on the basis of user input data, operation history data, or sensing data, and to adjust the prompt data for the generative AI model according to the estimated emotional state so as to change a tone, an expression, or an information amount of the generated image description text or the summary text.

### (Supplementary 3)

The system according to supplementary 1,
wherein the processor is configured to convert the summary text into text data in a format that is usable as input to a speech synthesis device for audio output processing for visually impaired users, store the text data in association with the visual information in a data storage device, and transmit response data including the text data to the terminal.

What is claimed is:

1. A system comprising:
circuitry configured to:
receive, via a communication interface coupled to a packet-switched network, prompt data from a terminal device operated by a user, and analyze the prompt data using a natural language processing resource to extract feature terms;
retrieve, based on the extracted feature terms, visual information from an information source via the packet-switched network, and select visual information from a plurality of pieces of acquired visual information in accordance with a relevance criterion;
input the selected visual information to an image analysis resource and acquire analysis result data comprising object information and scene information;
construct a prompt data structure for a generative neural network model based on the analysis result data, and cause the generative neural network model to generate a descriptive output sentence describing content of the visual information;
cause the generative neural network model to generate, based on the descriptive output sentence and supplemental attribute data stored in a storage device, a composite output sentence incorporating the supplemental attribute data; and
transmit, via the communication interface, the composite output sentence and the visual information to the terminal device for presentation via a user interface of the terminal device.

2. The system according to claim 1, wherein the circuitry is configured to estimate an emotional state of the user based on at least one of expression data, audio signal data, or interaction pattern data received from the terminal device, and to adjust at least one of a content, a style, or a presentation order of the composite output sentence in accordance with the estimated emotional state.

3. The system according to claim 2, wherein the circuitry is configured to estimate the emotional state using an emotion recognition resource comprising a neural network classifier that outputs a probability distribution over a plurality of discrete emotional state categories.

4. The system according to claim 1, wherein the circuitry is configured to store the descriptive output sentence, the composite output sentence, and the visual information in association with identification information in the storage device, and to transmit the stored data to a content distribution apparatus via the packet-switched network.

5. The system according to claim 1, wherein the natural language processing resource performs tokenization, part-of-speech tagging, and named entity recognition on the prompt data, and wherein the extracted feature terms comprise nouns and named entities with stop words removed.

6. The system according to claim 5, wherein the circuitry is configured to normalize the extracted feature terms by applying lemmatization, case conversion, and synonym mapping using a predefined dictionary prior to retrieving the visual information.

7. The system according to claim 1, wherein the image analysis resource comprises a convolutional neural network or a transformer-based vision model that generates feature maps from pixel data of the selected visual information and outputs object labels, scene labels, and confidence scores.

8. The system according to claim 7, wherein the circuitry is configured to filter the object labels and scene labels by retaining labels having confidence scores exceeding a predetermined threshold, and to group retained labels into categories to form the analysis result data.

9. The system according to claim 1, wherein constructing the prompt data structure comprises converting the object information and scene information into textual fragments, combining the textual fragments with instruction parameters specifying a language, a style, and a length constraint for the descriptive output sentence.

10. The system according to claim 9, wherein the generative neural network model comprises a transformer architecture with self-attention layers, and wherein the circuitry is configured to control inference parameters comprising at least one of a temperature parameter, a top-k sampling threshold, or a maximum output length during generation of the descriptive output sentence.

11. The system according to claim 1, wherein causing the generative neural network model to generate the composite output sentence comprises constructing a second prompt data structure including the descriptive output sentence as contextual information and the supplemental attribute data as content to be incorporated, and transmitting the second prompt data structure to the generative neural network model.

12. The system according to claim 11, wherein the second prompt data structure includes instructions specifying that the generative neural network model should output a concise sentence that incorporates the supplemental attribute data in a contextually coherent manner with respect to the descriptive output sentence.

13. The system according to claim 1, wherein the circuitry is configured to perform post-processing on the composite output sentence comprising validation against a maximum character count, detection and removal of prohibited terms, and style normalization.

14. The system according to claim 1, wherein the circuitry is configured to perform post-processing on the descriptive output sentence comprising trimming whitespace, ensuring terminal punctuation, and verifying that a length of the descriptive output sentence does not exceed a predetermined limit.

15. The system according to claim 1, wherein the circuitry is configured to set the composite output sentence as alternative text in attribute information of a structured document associated with the visual information.

16. The system according to claim 15, wherein the circuitry is configured to input the composite output sentence to a speech synthesis resource to generate an audio signal, and to transmit the audio signal to the terminal device for auditory output.

17. The system according to claim 1, wherein the circuitry is configured to store history information comprising the prompt data, the analysis result data, the descriptive output sentence, and the composite output sentence in the storage device, and to update at least one of a model selection condition and a generation condition parameter for a subsequent generation process based on the stored history information.

18. A system comprising:
circuitry configured to:
receive, via a communication interface coupled to a packet-switched network, prompt data from a terminal device, and analyze the prompt data using a natural language processing resource to extract feature terms;
retrieve visual information based on the extracted feature terms from an information source via the packet-switched network, input the visual information to an image analysis resource comprising a convolutional neural network or a transformer-based vision model, and acquire analysis result data comprising object labels, scene labels, and confidence scores;
construct a first prompt data structure based on the analysis result data and cause a generative neural network model comprising a transformer architecture with self-attention layers to generate a descriptive output sentence describing content of the visual information;
construct a second prompt data structure comprising the descriptive output sentence and supplemental attribute data stored in a storage device, and cause the generative neural network model to generate a composite output sentence incorporating the supplemental attribute data;
estimate an emotional state of a user of the terminal device and adjust at least one of a content or a presentation order of the composite output sentence based on the estimated emotional state; and
transmit the composite output sentence and the visual information to the terminal device for presentation via a user interface of the terminal device.

19. The system according to claim 18, wherein the circuitry is configured to set the composite output sentence as alternative text in attribute information of a structured document associated with the visual information, and to input the composite output sentence to a speech synthesis resource to generate an audio signal for auditory output.

20. A method comprising:
receiving, via a communication interface coupled to a packet-switched network, prompt data from a terminal device operated by a user, and analyzing the prompt data using a natural language processing resource to extract feature terms;
retrieving, based on the extracted feature terms, visual information from an information source via the packet-switched network, and selecting visual information from a plurality of pieces of acquired visual information in accordance with a relevance criterion;
inputting the selected visual information to an image analysis resource and acquiring analysis result data comprising object information and scene information;
constructing a prompt data structure for a generative neural network model based on the analysis result data, and causing the generative neural network model to generate a descriptive output sentence describing content of the visual information;
causing the generative neural network model to generate, based on the descriptive output sentence and supplemental attribute data stored in a storage device, a composite output sentence incorporating the supplemental attribute data; and
transmitting, via the communication interface, the composite output sentence and the visual information to the terminal device for presentation via a user interface of the terminal device.
